(19) United States
(12) Patent Application Publication
(10) Pub. No.: US 2026/0134324 A1
(43) Pub. Date: May 14, 2026

(54) Deep Physics Heterogeneous Graph Network Compute Engine for Autonomous Control System

(71) Applicant: PassiveLogic, Inc., Hollafay, UT (US)

(72) Inventors: Troy Aaron Harvey, Holladay, UT (US); Majid Karami, Holladay, UT (US)

(21) Appl. No.: 19/376,802

(22) Filed: Oct. 31, 2025

Related U.S. Application Data
(60) Provisional application No. 63/718,932, filed on Nov. 11, 2024.

(51) Int. Cl. G06N 10/40

(52) U.S. Cl. CPC G06N 10/40

(57) ABSTRACT

The present disclosure relates to systems and methods for timestep computation within a heterogeneous graph-based simulation engine used for digital twin and autonomous control applications. The engine represents real-world systems as an ontological data graph comprising heterogeneous physics nodes, each modeling localized physical behaviors using quanta that carry state information. During a simulation timestep, a node receives quanta packets, extends its internal quanta space, mixes new and existing quanta according to device behaviors, applies a timestep transformation, and outputs updated quanta to connected nodes. The disclosed approach introduces an “overstepping” mechanism that maintains numerical stability when timestep durations exceed the physical capacity of local devices, enabling accurate and efficient simulation. The system further supports heterogeneous quanta types—such as thermal, fluidic, mechanical, or electrical—and normalizes their interactions through unified energy and state transfer relationships.

### FIELD OF INVENTION

Various embodiments described herein relate to ontological data graphs, heterogenous physics graphs, computing graphs, and computing timestep management for quantum graph computation.

### SUMMARY

This summary is provided to introduce a selection of concepts in a simplified form that are further described below in the Detailed Description section. This summary does not identify required or essential features of the claimed subject matter.

In various embodiments described herein, a method is disclosed, which includes: a timestep and a device, the device having a quanta, and a original volume, the original quanta volume having an original state; the method comprising: during a timestep in a simulation: receiving a new quanta volume, the new quanta volume based on size of the timestep, the new quanta volume having a new quanta state; extending size of the quanta to accommodate original quanta volume plus the new quanta volume; moving the new quanta volume into the device; mixing state of the new quanta volume and the state of the original quanta volume producing a timestep volume; applying a timestep state to the timestep volume; and moving the new quanta volume out of the device.

Various embodiments are described wherein, mixing state of the new quanta volume and original quanta volume produces a uniform quanta volume.

Various embodiments are described wherein, further comprising a direction, and wherein moving the new quanta volume into the device includes moving in the direction into the device.

Various embodiments are described wherein, moving the new quanta volume out of the device includes moving in the direction out of the device.

Various embodiments are described that further includes determining a timestep.

Various embodiments are described where the neural network is a recurrent neural network.

Various embodiments are described where the new quanta volume is based on size of the timestep.

Various embodiments are described wherein, further comprising returning the quanta volume to the original size.

Various embodiments are described wherein, a computing system is disclosed that determines device behavior during a timestep. This computing system includes one or more physical computer processors and non-transient electronic storage, and a simulation engine executed by a processor of the computing system to simulate real-time device behavior of a simulated building system including a timestep, and a device, the device having a quanta, an original size, and original quanta volume, the original quanta volume having a size, an original quanta state; comprising: during a timestep: receiving a new quanta volume, the new quanta volume based on size of the timestep, the new quanta volume having a new quanta state; extending size of the device quanta to accommodate original quanta volume plus the new quanta volume; moving the new quanta volume into the device; mixing new quanta volume and the original quanta volume producing a timestep volume; applying a timestep state to the timestep volume; and moving the new quanta volume out of the device.

Various embodiments are described wherein, mixing new quanta volume includes using the new quanta state and the original quanta state to determine the timestep volume.

Various embodiments are described wherein, the device is a pump, a storage area, or a heat exchanger.

Various embodiments are described wherein, the quanta is a liquid, a compressible gas, or a representation of a physical object.

Various embodiments are described wherein, the state is temperature.

Various embodiments are described wherein, a non-transient computer-readable storage medium is disclosed, which includes a plurality of instructions which, when executed by a computer cause the computer to execute a simulate timestep. This includes a simulation engine executed by a processor of the computer to simulate real-time device behavior of a simulated building system including a timestep, and a device, the device having a quanta, an original size, and original quanta volume, the original quanta volume having a size, an original quanta state; comprising: during a timestep: receiving a new quanta volume, the new quanta volume based on size of the timestep, the new quanta volume having a new quanta state; extending size of the device to accommodate original quanta volume plus the new quanta volume; moving the new quanta volume into the device; mixing state of the new quanta volume and the original quanta volume producing a timestep volume; applying a timestep state to the timestep volume; and moving the new quanta volume out of the device.

### BRIEF DESCRIPTION OF THE FIGURES

In order to better understand various example embodiments, reference is made to the accompanying drawings, wherein:

FIG. 1 an example system for implementation of various embodiments;

FIG. 2 illustrates an example distributed computing system environment for deployment of various embodiments;

FIG. 3 illustrates an example digital twin for use in various embodiments;

FIG. 4 illustrates an example system for use in various embodiments;

FIGS. 5A and 5B illustrate example subsystems for use in various embodiments;

FIG. 5C illustrates an example device broken down into components;

FIG. 5D illustrates example components broken down into nodes;

FIG. 5E illustrates example resistances for a node;

FIG. 6A illustrate some correlations between quanta, actors, behaviors and properties;

FIG. 6B illustrates some example quanta and interfaces for use in various embodiments;

FIG. 6C illustrate example actors for use in various embodiments;

FIGS. 7A, 7B, 7C, and 7D illustrate aspects of equipment and quanta;

FIG. 8 illustrates aspects of the internal mixing quanta form;

FIGS. 9A and 9B illustrate some aspects of mixing;

FIG. 9C gives an example of a subsystem updating during a timestep;

FIG. 9D illustrates some different quanta forms;

FIG. 9E illustrates some aspects of mixing forms and flow through forms;

FIG. 9F illustrates some aspects of choosing an appropriate size for a timestep;

FIG. 9G illustrates some aspects of constant media and variable media;

FIG. 9H illustrates aspects of a weakest link in a timestep;

FIGS. 10A-10B illustrate aspects of flow determination;

FIG. 11 illustrates a method of determining device behavior during a timestep;

FIG. 12 illustrates an example hardware device for implementing a controller, server, or other device for defining or utilizing a timestep within a digital twin.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” refers to a non-exclusive “or” (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

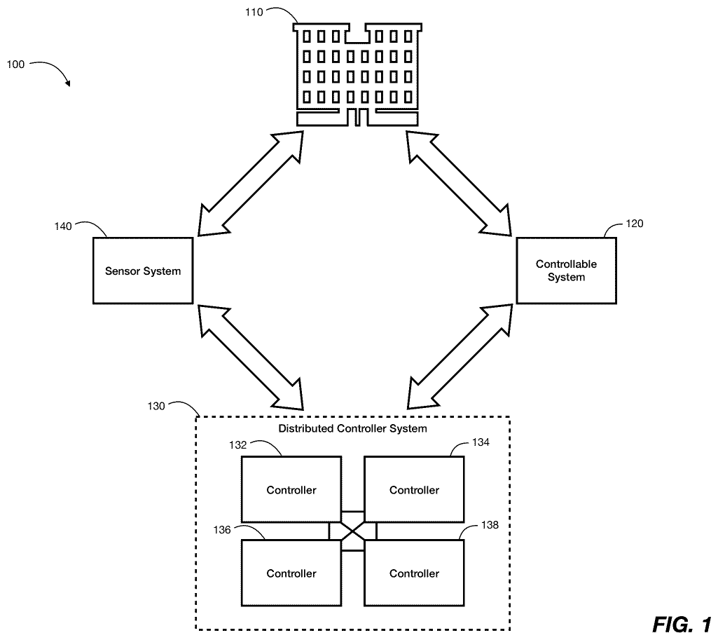

The technical character of embodiments described herein will be apparent to one of ordinary skill in the art, and will also be apparent in several ways to a wide range of attentive readers. Some embodiments address technical activities that are rooted in computing technology, such as determining more efficient ways to perform simulations. Numerous simulations are designed such that the end state is, essentially, a system of linear equations, which can be represented in matrix form. In these simulation frameworks, the identification of suitable time intervals is achieved through the evaluation of eigenvalues associated with the resulting matrix. However, it is important to acknowledge that not all simulation scenarios lend themselves to reduction as linear equations. Such embodiments include simulations run with heterogeneous networks, as discussed with reference to FIGS. 1-3. In such embodiments, for example, these simulations may simulate energy flow in a building or other structure. The energy flow simulation may produce control sequences for various equipment (such as, for example, pumps, boilers, radiators, etc.) that allow a building to run with much more energy efficiency. The size of the timestep that the simulation runs is very important. Short timesteps require more frequent calculations or updates, which can strain computational resources and potentially lead to slower performance or system instability. Additionally, if the timestep is too large for the timescale of the underlying phenomenon being modeled or simulated, important details or dynamics may be missed, resulting in inaccurate or incomplete results. When timesteps in a system or process are set to be too large, it can give rise to various problems. One significant issue is the loss of temporal resolution, leading to a lack of precision in capturing dynamic changes.

Using a larger timestep in a simulation may offer benefits. For example, a large timestep reduces the number of calculations required for a given time, and thus runs faster. With a larger timestep, computational resources, such as CPU time and memory, required for the simulation are reduced. Similarly, large timesteps make it practical to simulated extended time periods that would otherwise be computationally prohibitive. However, too-large timesteps can also cause problems. For example, important transient events or rapid fluctuations can be missed or inaccurately represented, potentially resulting in misleading or erroneous results. Furthermore, a large timestep may hinder the system's ability to capture and respond to rapid changes, leading to delayed or inaccurate simulations. This can be particularly problematic in real-time systems or time-sensitive processes where fine-grained temporal accuracy is essential. In some cases, a large timestep can introduce numerical instability or inaccuracies in the numerical integration methods employed. Further, if a chosen timestep is just a little too large, the results may not be off enough to easily detect, but may nonetheless produce undesirable results. This may lead to incorrect answers being reported as accurate.

Accordingly, various methods are described herein for running a simulation with a timestep that would otherwise be considered too large for the individual parts of the system without destabilization. This allows for much more efficient computer usage, for the processes within the computer to run more efficiently while maintaining the accuracy. Various methods are also described herein for adaptive timestep computation within a heterogeneous graph-based simulation engine. In such embodiments, each subsystem or node dynamically adjusts its timestep resolution according to local physical conditions and quanta state transitions, rather than relying on a fixed global timestep. The adaptive mechanism evaluates rate-of-change metrics-such as energy gradients, flow rates, or phase transition derivatives—to determine whether finer or coarser timestep increments are required to maintain numerical stability and physical accuracy. When a node exhibits rapid state evolution, the engine automatically subdivides the current timestep, while regions of steady behavior are advanced using larger steps to conserve computational resources. This approach enables synchronized, multi-resolution simulation across diverse physics domains, ensuring that each actor in the compute graph operates at an appropriate temporal granularity while maintaining global simulation coherence and computational efficiency.

### 1. Overview

Some types of simulations advance by timesteps. Ideally, a simulation has a stable and accurate system that runs in a minimal time. Simulation models continue to grow in size and scope, such that shortening running times allows more complexity in simulations while still being able to run them on current computers. Many simulations are built using a mathematical model; continuous simulations are often created using differential equations. These differential equations can be solved simultaneously using certain parameters to determine a timestep for the simulation. Other simulations may be run iteratively to determine optimal timesteps. However, not all simulation methods consist of equations that can be solved simultaneously. Decentralized simulation systems are those that are graph oriented. That is, rather than running consecutively, graph-based simulations run from one edge of the graph to another—in an equipment simulator, for example, a first actor (say, a boiler) will be simulated with its own set of equations, then pass on the results to a second actor (e.g., a pump) which calculates, then passes its results to a third actor (e.g. a radiator), which calculates, then passes on its output back to the first actor—the simulated boiler, etc. Decentralized simulation systems generally cannot operate using conventional timestep methods, as their underlying physics equations must be solved simultaneously across interconnected nodes. Other methods for solving decentralized system timesteps, such as those employing iterative convergence techniques, are prohibitively expensive in terms of CPU usage and processing time. These approaches require repeatedly running the simulation to achieve convergence, and often fail to reach an optimal or stable solution within practical time constraints. Thus, systems and methods to determine optimal timesteps for decentralized systems are welcome, and are described herein

Timesteps of a certain small size may require modifications in the way simulations run to avoid destabilizing a simulation. One approach to determining the appropriate timestep size involves considering the maximum material capacity of the simulation actors responsible for performing their tasks. For instance, in the context of an equipment simulator, when the simulation progresses through a timestep, it involves moving a quantity of material equivalent to one timestep into the equipment representations. This material could represent various substances like water or objects on a conveyor belt. This approach typically works well for equipment designed for storage, as these systems usually have adequate capacity to accommodate the additional material. However, some equipment types, such as pipes, function as mere passageways and can hold only minimal amounts of material. Using such small elements as the basis for timestep determination can result in impractically tiny timesteps. These extremely small timesteps, in turn, lead to simulations that demand an exorbitant amount of computational resources and take an excessively long time to complete. To address this challenge, the described methods and systems offer a solution that enables simulations to run with timesteps that necessitate larger quantities of material to be present or flow through equipment representations, even when those representations inherently have limited capacity.

To adapt to timesteps that surpass the limitations of certain equipment, one approach involves a method we are calling “overpassing.” In one implementation discussed herein, the new quanta packet (representing the material to be processed during the timestep) is added to the existing quanta packet within the equipment, effectively blending the materials. Then, material equivalent to the input packet is removed. This process effectively facilitates the movement of material through the equipment while modifying its state in a manner that preserves the stability of the simulation.

The present disclosure relates to systems and methods for timestep computation within a heterogeneous graph-based simulation engine used for digital twin and autonomous control applications. The engine represents real-world systems as an ontological data graph comprising heterogeneous physics nodes, each modeling localized physical behaviors using quanta that carry state information. During a simulation timestep, a node receives quanta packets, extends its internal quanta space, mixes new and existing quanta according to device behaviors, applies a timestep transformation, and outputs updated quanta to connected nodes. The disclosed approach introduces an “overstepping” mechanism that maintains numerical stability when timestep durations exceed the physical capacity of local devices, enabling accurate and efficient simulation without iterative or relaxation-based convergence methods. The system further supports heterogeneous quanta types—such as thermal, fluidic, mechanical, or electrical—and normalizes their interactions through unified energy and state transfer relationships. These techniques provide scalable, distributed computation of coupled physical systems, allowing real-time simulation, learning, and control within a unified deep-physics compute graph.

FIG. 1 illustrates an example system 100 for implementation of various embodiments. As shown, the system 100 may include an environment 110, some aspect of which is affected by a controllable system 120. The behavior of the controllable system 120 is, in turn, controlled by a distributed controller system 130. To obtain information useful in making control decisions, the distributed controller system 130 receives data from a sensor system 140 which, in turn, generates its data based on observations from the environment 110.

According to one specific example, system 100 may describe a heating, ventilation, and air conditioning (HVAC) application. As such the environment 110 may be a building whose temperature is to be controlled by the controllable system 120. The controllable system 120 may be the HVAC system itself, which may be controllable to distribute warm or cool air throughout the building 110. Thus, the controllable system 120 may include HVAC equipment such as pumps, boilers, radiators, chillers, fans, vents, etc. The sensor system 140 may include a set of temperature sensors distributed throughout the building 110 to collect and report temperature values.

While various embodiments disclosed herein may be described in the context of such an HVAC application, it will be apparent that the techniques described herein may be applied to other applications including, for example, applications for controlling a lighting system, a security system, an automated irrigation or other agricultural system, a power distribution system, a manufacturing or other industrial system, or virtually any other system that may be controlled. Further, the techniques and embodiments may be applied other applications outside the context of controlled systems. Various modifications to adapt the teachings and embodiments to use in such other applications will be apparent.

As shown, the distributed controller system 130 includes four controllers 132, 134, 136, 138 in communication with one another. The controllers 132, 134, 136, 138 may be located within the environment 110, at another location (such as another environment similar to the environment 110 or in a cloud data center), or some combination thereof. Each controller 132, 134, 136, 138 may be connected to one or more devices, such as individual devices of the controllable system 120 or sensor system 140. Such connection may be direct or indirect (e.g., via one or more intermediate devices such as a network), wired or wireless, or any other type of connection that would enable communication between devices. In some embodiments, each controller 132, 134, 136, 138 may be connected to those devices of the controllable system 120 or sensor system 140 that are physically most proximate to that respective controller 132, 134, 136, 138. For example, where the environment 110 is a building with four floors, the controllers 132, 134, 136, 138 may be installed one on each such floor and then connected to the devices of the controllable system 120 or sensor system 140 physically located on the same floor. Alternatively, devices of the controllable system 120 may be distributed amongst controllers 132, 134, 136, 138 via criteria other than physical proximity, such as demand of the devices on the each controller 132, 134, 136, 138.

The controllers 132, 134, 136, 138 may be identical to each other or may employ different hardware or software. For example, two controllers 132, 134 may be full featured controllers while the other two controllers 136, 138 may be satellite controllers with limited capabilities with respect to the full featured controllers. As another example, one or more of the controllers 132, 134, 136, 138 may be specialized in one or more respects, deployed to work on only a subset of tasks associated with controlling the controllable system 120. As such, the controllers 132, 134, 136, 138 may implement partial or full redundancy of functionality or may divide functionality among themselves (either by pre-installation component design or by post-installation coordination or agreement) to achieve a fully functional distributed controller system 130. While the teachings and embodiments disclosed herein will be described with respect to fully-redundant, fully-featured controllers 132, 134, 136, 138 (unless otherwise noted), modifications for applications of the teachings and embodiments for application to such alternative controller 132, 134, 136, 138 arrangements will be apparent. It will also be apparent that other embodiments may include a greater or fewer number of controllers. In some such embodiments, the system 100 may include only a single controller, rather than multiple controllers cooperating in a distributed manner. Various modifications in such alternative embodiments will be apparent.

Various methods for implementing a distributed controller system 130 may be employed for coordinating the functions of the controllers 132, 134, 136, 138. For example, the controllers 132, 134, 136, 138 may coordinate to elect a single controller 132, 134, 136, 138 to take the function of leader controller, while the remaining controllers 132, 134, 136, 138 become follower controllers. In such an arrangement, each follower controller may perform some limited functionality, such as receiving sensor data from those devices in the sensor system 140 attached to that follower controller, committing such sensor data 226 to a database available to the other controllers 132, 134, 136, 138, ensuring proper connections and operation of devices of the controllable system 120 attached to that follower controller, performing fault detection for one or more field devices 296, or calculating derived “sensor” or otherwise predicting data for areas or components where direct observation (e.g., via a physical sensor device) is not possible.

Meanwhile, the elected leader controller may be responsible for additional functionality such as, for example, training machine learning models, running simulations, and making control decisions for the controllable system 120. In some embodiments, the elected leader controller may rely on the remaining controllers 132, 134, 136, 138 to assist in the performance of these tasks by distributing work among the follower controllers according to various distributed work paradigms that may be employed. For example, the leader controller may break a task to be performed into multiple smaller steps or work packages, transmit the steps or work packages to the follower controllers for performance, receive the sub-results of the steps or work packages back when the work is completed, and use the sub-results to arrive at an ultimate result (e.g., a further trained model, a completed simulation or set of simulations, or a control decision). With regard to control decisions or other actions involving communication with devices of the controllable system 120 or the sensor system 140, the leader controller may determine to which of the controllers 132, 134, 136, 138 the device is connected and send the communication to that controller 132, 134, 136, 138 to then be passed on to the intended device.

It will be understood that FIG. 1 may represent a simplification in some respects. For example, in some embodiments, one or more devices may be both a controllable device (belonging to the controllable system 120) and a sensor device (belonging to the sensor system 140). For example, a controllable pump may have an integrated sensor that reports an observed pressure back to the distributed controller system 130. In some embodiments, there may be multiple controllable systems 120, multiple sensor systems 140, or other systems (not shown) involved in implementing the overall system 100, each of which may or may not be in communication with the distributed controller system 130. For example, the distributed controller system 130 may control both an HVAC system and a lighting system, which may be implemented as two independent controllable systems 120. As another example, the distributed controller system 130 may obtain sensor data from both a set of sensors the distributed controller system 130 manages as well as a set of sensors managed by a third party service (e.g., as may be made available through an API or other network-based service) and, as such, there may be multiple independent sensor systems 140 that inform the operation of the distributed controller system 130. In some embodiments, the distributed controller system 130 may manage controllable systems 120 for multiple environments 110 (e.g., the HVAC systems for two or more separate buildings) or may be in communication with other distributed controller systems 130 associated with implementations of systems similar to system 100 for other environments 110 (e.g., to extend the processing capacity through distribution of work to additional controllers, to execute multi-building control actions, or to gather information from other environments such as predicted power usage). Thus, where the environment 110 is a building, one or more distributed controller systems 130 may implement not only a “smart building” but a “smart city” of multiple buildings coordinating their operations. Various modifications for replicating or otherwise adapting the teachings herein across additional environments, controllable systems, distributed controller systems, or sensor systems will be apparent.

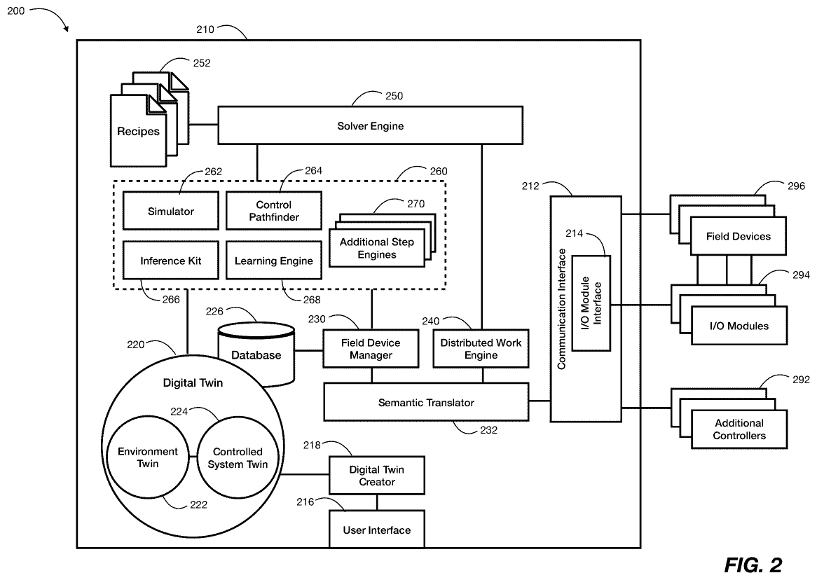

FIG. 2 illustrates an example system 200 for implementing a controller device 210. The controller device 210 may correspond to one of the controllers 132, 134, 136, 138 of the example system 100 and, as such, may communicate with additional controllers 292 (which may correspond to the remaining controllers 132, 134, 136, 138) to implement a distributed controller system such as the distributed controller system 130. In other embodiments, where only a single controller 210 is used, the additional controllers 292 may not be present. In some embodiments, the controller 210 may be or include a building automation system (BAS) or building management system (BMS).

The controller 210 also communicates with multiple field devices 296. These field devices 296 may correspond to one or more devices belonging to the controllable system 120 or sensor system 140 of the example system 100. Similarly, other field devices 296 may communicate with the additional controllers 292. As such, the field devices 296 may include devices that may be controlled to affect some state of an environment (e.g., HVAC equipment that cooperate to manage a building temperature) or sensor devices that report back information about the environment (e.g., temperature sensors deployed among the different environmental zones of the building).

As noted above, virtually any connection medium (or combination of media) may be used to enable communication between the controller 210 and the additional controllers 292 or field devices 296, including wired, wireless, direct, or indirect (i.e., through one or more intermediary devices, such as in a network) connections. As used herein, the term “connected” as used between two devices will be understood to encompass any form of communication capability between those devices. To enable such connections, the controller 210 includes a communications interface 212. As will be explained in greater detail below, the communication interface 212 may include virtually any hardware for enabling connections with additional controllers 292 or field devices 296, such as an Ethernet network interface card (NIC), WiFi NIC, or USB connection.

In some embodiments, one or more connections to other devices may be supported by one or more I/O modules 294. The I/O modules 294 may provide further hardware or software used in controlling or otherwise communicating with field devices 296 having specific protocols or other particulars for such communication to occur. For example, where a field device 296 includes a motor to be controller, an I/O module 294 having components such as a motor control block, motor drivers, pulse width modulation (PWM) control, or other components relevant to motor control may be used to connect that field device 296 to the controller 210. Various additional components for inclusion in different I/O modules 294 for control of different particular field devices 296. Additional features, such as current or voltage monitoring or overcurrent protection may also be incorporated into the I/O modules 294. To enable communication with the I/O modules 294, the communication interface 212 may include an I/O module interface 214. In various embodiments, the I/O module interface 214 may be a set of electrical contacts for contact with complementary pins of the I/O modules 294. A communication protocol, such as USB, may be implemented over such contacts and pins to enable passing of information between the controller 210 and I/O modules 294. In other embodiments, the I/O module interface 214 may include the same interfaces previously described with respect to the communication interface. In various alternative embodiments, on the other hand, some or all of these more particular components may be incorporated into the controller 210 itself, and some or all of the I/O modules 294 may be omitted from the system 200. Various additional techniques for implementing an I/O module 294 according to various embodiments, may be described in U.S. Pat. Nos. 11,229,138; and 11,706,891, the entire disclosures of which are hereby incorporated herein by reference.

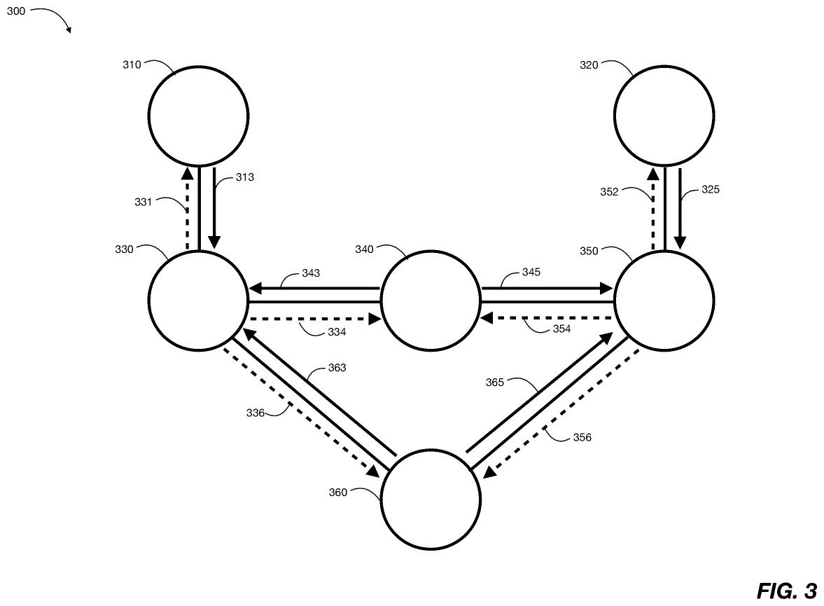

According to various embodiments, the controller 210 utilizes a digital twin 220 that models at least a portion of the system it controls and may be stored in a database 226 along with other data. As shown, the digital twin 220 includes an environment twin 222 that models the environment whose state is being controlled (e.g., a building) and a controlled system twin 224 that models the system that the controller 210 controls (e.g., an HVAC equipment system). A digital twin 220 may be any data structure that models a real-life object, device, system, or other entity. Examples of a digital twin 220 useful for various embodiments will be described in greater detail below with reference to FIG. 3. While various embodiments will be described with reference to a particular set of heterogeneous and omnidirectional neural network digital twins, it will be apparent that the various techniques and embodiments described herein may be adapted to other types of digital twins. Further, while the environment twin 222 and controlled system twin 224 are shown as separate structures, in various embodiments, these twins 222, 224 may be more fully integrated as a single digital twin 220. In some embodiments, additional systems, entities, devices, processes, or objects may be modeled and included as part of the digital twin 220.

In various embodiments, a user may create or modify the digital twin 220. In such embodiments, the controller 210 may include a user interface 216 through which the user accesses a digital twin creator 218 to create or modify the digital twin 220. For example, the user interface 216 may include a display, a touchscreen, a keyboard, a mouse, or any device capable of performing input or output functions for a user. In some embodiments, the user interface 216 may instead or additionally allow a user to use another device for such input or output functions, such as connecting a separate tablet, mobile phone, or other device for interacting with the controller 210.

The digital twin creator 218 may provide a toolkit for the user to create digital twins 220 or portions thereof. For example, the digital twin creator 218 may include a tool for defining the walls, doors, windows, floors, ventilation layout, and other aspects of a building construction to create the environment twin 222. The tool may allow for definition of properties useful in defining a digital twin 220 (e.g., for running a physics simulation using the digital twin 220) such as, for example, the materials, dimensions, or thermal characteristics of elements such as walls and windows. Such a tool may resemble a computer-aided drafting (CAD) environment in many respects. According to various embodiments, unlike typical CAD tools, the digital twin creator 218 may digest the defined building structure into a digital twin 220 model that may be computable, trainable, inferenceable, and queryable, as will be described in greater detail below.

In addition or alternative to building structure, the digital twin creator 218 may provide a toolkit for defining virtually any system that may be modeled by the digital twin 220. For example, for creating the controlled system twin 224, the digital twin creator 218 may provide a drag-and-drop interface where various HVAC equipment (e.g., boilers, pumps, valves, tanks, etc.) may be placed and connected to each other, forming a system (or a group of systems) that reflect the real world controllable system 120. In some embodiments, the digital twin creator 218 may drill even further down into definition of twin elements by, for example, allowing the user to define individual pieces of equipment (along with their behaviors and properties) that may be used in the definition of systems. As such, the digital twin creator 218 provides for a composable twin, where individual elements may be “clicked” together to model higher order equipment and systems, which may then be further “clicked” together with other elements.

In other embodiments, the digital twin 220 may be created by another device (e.g., by a server providing a web- or other software-as-a-service (SaaS) interface for the user to create the digital twin 220, or by a device of the user running such software locally) and later downloaded to or otherwise synced to the controller 210. In other embodiments, the digital twin 220 may be created automatically by the controller 210 through observation of the systems it controls or is otherwise in communication with. In some embodiments a combination of such techniques may be employed to produce an accurate digital twin-a first user may initially create a digital twin 220 using a SaaS service, the digital twin 220 may be downloaded to the controller 210 where a second user further refines or extends the digital twin 220 using the digital twin creator 218, and the controller 210 in operation may adjust the digital twin 220 as needed to better reflect the real observations from the systems it communicates with. Various additional techniques for defining, digesting, compiling, and utilizing a digital twin 220 according to some embodiments may be described in U.S. Pat. No. 10,845,771; and U.S. patent application publication numbers 2021/0383200; 2021/0383235; and 2022/0215264, the entire disclosures of which are hereby incorporated herein by reference.

In addition to storing the digital twin 220, the database 226 may store additional information that is used by the controller 210 to perform its functions. For example, the database 226 may hold tables that store sensor data collected from field devices 296 or control actions that should be issued to field devices 296. Various additional or alternative information for storage in the database 226 will be apparent. In various embodiments, the database 226 implements database replication techniques to ensure that the database 226 content is made available to the additional controllers 292. As such, changes that the controller 210 makes to the database 226 content (including the digital twin 220) may be made available to each of the controllers 292, while database changes made by the additional controllers 292 are similarly made available in the database 226 of the controller 210 as well as the other additional controllers 292.

A field device manager 230 may be responsible for initiating and processing communications with field devices 296, whether via I/O modules 294 or not. As such the field device manager 230 may implement multiple functions. For sensor management, the device manager 230 may receive (via the communication interface 212 and semantic translator 232) reports of sensed data. The field device manager 230 may then process these reports and place the sensed data in the database 226 such that it is available to the other components of the controller 210. In managing sensor devices, the field device manager 230 may be configured to initiate communications with the sensor devices to, for example, establish a reporting schedule for the sensor devices and, where the sensor devices form a network for enabling such communications, the network paths that each sensor device will use for these communications. In some embodiments, the field device manager 230 may receive (e.g., as part of sensor device reports) information about the sensor health and then use this information to adjust reporting schedule or the network topology. For example, where a sensor device reports low battery or low power income, the controller 210 may instruct that sensor device to report less frequently or to move to a leaf node of the network topology so that its power is not used to perform the function of routing messages for other sensors with a better power state. Various other techniques for managing a group or swarm of sensor devices will be apparent.

The field device manager 230 may also be responsible for managing and verify the connections of field devices 296 to the I/O modules 294. For example, configuration data stored in the digital twin 220 or elsewhere in the database 226 may indicate that a particular field device 296 is expected to be connected to a particular I/O module 294 having a particular set of supporting components, that the particular I/O module 294 is expected to be connected to a particular I/O module interface 214, and that communications through the particular I/O module 294 are expected to occur according to a particular set of protocols. The field device manager 230 may test (e.g., by sending one or more test communications) that the particular field device 296 is actually set up according to these configurations (e.g., if communications are successful or not) and then take remedial action if there is an installation problem. In some cases, the field device manager 230 may simply update the configuration information if doing so will solve the incorrect installation (e.g. the I/O module 294 is connected to a different I/O module interface 214 but is otherwise working, the I/O module 294 is configured to communicate according to a different protocol). In other cases, the field device manager 230 may prompt a user that these is an issue with the connection and ask for the user to take remedial action (e.g., reconfigure settings at the controller 210 or physically relocate, replace, or otherwise reinstall an I/O module 294, connection wires, or the field device 296). As such, the field device manager 230 in some embodiments provides a software toolset for the user via the user interface 216, a web portal, or elsewhere. In some embodiments, such a user interface 216 may be a graphical representation of the controller 210, I/O modules 294, and field device 296 connections thereto that allows the user to see how these devices are expected by the controller 210 to be installed. In some embodiments, the toolset may also allow the user to reconfigure these expectations rather than physically changing the system of devices (e.g., by dragging an I/O module graphic to a different connection graphic, or by changing a connection type for one or more wiring terminal graphics of an I/O module graphic).

In some embodiments, in addition to the verification of I/O module 294 connections, the field device manager 230 may perform a fuller commissioning procedure. For example, the field device manager 230 may perform a series of tests on the field devices 296 that are connected to the controller 210 or on the full set of field devices 296 in the controllable system 120 or the sensor system 140 (particularly where the controller 210 has been elected as a leader controller). Accordingly, in some such embodiments, the field device manager 230 may communicate with the field devices 296 via the communication interface 212 to perform tests to verify that installation and behavior is as expected (e.g., as expected from simulations run against the digital twin 220 or from other configurations stored in the database 226 or otherwise available to the controller 210). Where the field device manager 230 drives testing of field devices 296 attached instead to one or more additional controllers 292, the testing may include communication with the additional controllers 292 (e.g., through use of the distributed work engine 240 or directly through the communications interface 212), such as test messages that the additional controllers 292 route to their connected field devices 296 or instructions for the additional controllers 292 to perform testing themselves and report results thereof.

In some embodiments, the testing performed by the field device manager 230 may be defined in a series of scripts, preprogrammed algorithms, or driven by artificial intelligence (examples of which will be explained below). Such tests may be very simple (e.g., “can a signal be read on a wire,” or “does the device respond to a simple ping message”), device specific (e.g., “is the device reporting errors according to its own testing,” “is the device reporting meaningful data,” “does the device successfully perform a test associated with its device type”), driven by the digital twin 220 (“does this device report expected data or performance when this other equipment is controlled in this way,” “when the device is controlled this way, do other devices report expected data”), at a higher system level (“does this zone of the building operate as expected,” “do these two devices work together without error”), or may have any other characteristics for verifying proper installation and functioning of a number of devices both individually and as part of higher order systems.

In some embodiments, a user may be able to define (e.g., via the user interface 216) at least some of the commissioning tests to be performed. In some embodiments, the field device manager 230 presents a graphical user interface (GUI) (e.g., via the user interface 216) for giving a user insight into the commissioning procedures of the field device manager 230. Such a GUI may provide an interface for selecting or otherwise defining testing procedures to be performed, a button or other selector for allowing a user to instruct the field device manager 230 to begin a commissioning process, an interface showing the status of an ongoing commissioning process, or a report of a completed commissioning process along with identification of which field devices 296 passed or failed commissioning, recommendations for fixing failures, or other useful statistics.

In some embodiments, the data generated by a commissioning process may be useful to further train the digital twin 220. For example, if activating a heating radiator does not cool a room as much as expected, there may be a draft or open window in the room that was not originally accounted for that can now be trained intro the digital twin 220 for improved performance. As such, in some embodiments, the field device manager 230 may log the commissioning data in a form useful for the learning engine 268 to train the digital twin 220, as will be explained in greater detail below.

In some embodiments, the field device manager 230 may also play a role in networking. For example, the field device manager 230 may monitor the health of the network formed between the controller 210 and the additional controllers 292 by, for example, periodically initiating test packets to be sent among the additional controllers 292 and reported back, thereby identifying when one or more additional controllers 292 are no longer reachable due to, e.g., a device malfunction, a device being turned off, or a network link going down. In a case where one of the additional controllers 292 had been elected leader, the field device manager 230 may call for a new leader election among the remaining reachable additional controllers 292 and then proceed to participate in the election according to any of various possible techniques.

With respect to runtime control of the field devices 296, while other components (such as the control pathfinder 264) may decide what control actions are to be taken and make them available to other components (e.g., by writing the desired actions to the database 226), the field device manager 230 may be responsible for issuing the commands to the field devices 296 that cause the desired action to occur. In some embodiments, where the controller 210 is elected leader controller, the field device manager 230 may issue commands not only to the field devices 296 connected to the controller 210 but also to the additional controllers 292. In other embodiments where the database 226 is available to multiple controllers 210, 292 (e.g., through database replication techniques, by allowing the additional controllers 292 to query the database 226 of the controller 210, or by making the database 226 available on a different accessible server) the respective field device managers 230 or analogous components of the additional controllers 292 may similarly notice updates to the desired control actions and issue commands to their respective attached field devices 296 to effect the desired controls. Various additional techniques for implementing a field device manager 230 according to various embodiments may be described in U.S. Pat. Nos. 11,477,905; 11,596,079; and U.S. patent application publication numbers 2022/0067226; 2022/0067227; 2022/0067230; and 2022/0070293, the entire disclosures of which are hereby incorporated herein by reference.

Various embodiments utilize a higher order language to direct operations internal to the controller 210 and additional controllers 292. As an example, while field devices 296 may be controlled or otherwise communicate according to various diverse semantics and protocols (e.g., BACnet, Modbus, Wirepas, Pulse-Width Modulation, Frequency Modulation, 1-Wire, Bluetooth Low Energy Mesh, Ethernet, WiFi, 24 VAC, Voltage signal, Current signal, Resistance signal, the higher order language itself, etc.), desired actions identified by the control pathfinder 264, written to the database 226, or issued by the field device manager 230 may be agnostic to these particular differences. As another example, while the actions that the field devices 296 can perform may be differentiated based on the characteristics of a device (a pump can be instructed to pump fluid, a fan can be instructed to spin), these actions may be abstracted (or semantically raised) into the same action (either of these devices may be instructed to cause quanta to move). Thus, when a BACnet pump is to be instructed to begin pumping fluid, rather than issuing a specific BACNet command that will activate that pump or issuing an instruction for the pump to begin pumping, the field device manager 230 may issue a command that the particular “transport” field device 296 begin to move quanta from its input to its output. Such a higher order language may be reflective of the high order at which the digital twin 220 is defined, as will be explained in greater detail below.

While some field devices 296 may natively understand the higher order language, others may still require communication according to their own native protocols. A semantic translator 232 may thus be responsible for translating higher order language communications received from the field device manager 230 or distributed work engine 240 into the appropriate lower level, protocol specific messages that will be sent via the communication interface 212. So, where the field device manager 230 issues a command for a particular transport field device 296 to begin moving quanta, the semantic translator 232 may semantically lower this command to a command for a pump to begin pumping fluid (or for a fan to begin spinning, etc., depending on the specifics of the device as may be defined in the digital twin 220) and then semantically translate this command to a BACnet message (or Modbus, etc., depending on the specifics of the device as may be defined in the digital twin 220) that will accomplish the lowered action. The semantic translator 232 may then transmit the fully-formed message to the appropriate recipient device via the communications interface 212. Thus, while the digital twin 220 and other internal components of the controller 210, may operate according to a semantically-raised language (which may be driven by a semantic ontology used in the digital twin 220), the digital twin 220 may additionally store information for the various field devices 296 useful in semantically lowering and translating this language to enable effective communication with the field devices 296. In various embodiments, the semantic translator 232 may work in the opposite direction as well, translating and raising incoming messages from the field devices 296, such that they may be interpreted and acted on according to the semantically raised language of the controller 210. Various techniques for implementing a semantic translator 232, a digital twin 220 ontology, or an internal semantically-raised language according to some embodiments may be disclosed in U.S. patent application publication numbers 2022/0066754; and 2022/0066761, the entire disclosures of which are incorporated herein by reference.

As shown, the controller 210 includes a distributed work engine 240 for guiding the distributed operation of the controller 210 with additional controllers 292. As such, the distributed work engine 240 may receive computation steps (e.g., from the solver engine 250) to be outsourced to other controllers 292, transmit the work (via the semantic translator 232 or communication interface 292) to the additional controllers 292, receive work results back, and pass them back to the solver engine 250. Such a workflow may be used when, for example, the controller 210 has been elected as a leader controller. The distributed work engine 240 may also implement the other side by receiving work requests from one or more additional controllers 292, passing the work requests to the solver engine 250 or directly to a step engine 260, receiving the result of the work, and transmitting the result back to the requesting controller 292. Such a workflow may be used when, for example, the controller 210 has been not elected as a leader controller and is, instead, a follower controller. In various alternative embodiments, the controller 210 may both issue work requests to other controllers 292 and execute work requests received from additional controllers 292, regardless of status as a leader or follower (if any). The distributed work engine 240 may perform additional functionality associated with managing a distributed compute system such as, for example, selecting particular ones of the additional controllers 292 to receive particular work requests, receiving load metrics or otherwise assessing compute health/capacity of the additional controllers 292, performing load balancing among the additional controllers 292, and deciding when to resend or reassign previously issued work requests, and when to time out previously issued work requests (too much time has elapsed, a sufficient number of other responses have been received, etc.) and instruct the solver engine 250 to move on with the next steps of a computation. Various additional techniques for implementing a distributed work engine 240 according to some embodiments may be described in U.S. Pat. No. 11,490,537, the entire disclosure of which is hereby incorporated herein by reference.

A solver engine 250 may be responsible for driving many, if not all, of the higher order functions of the controller 210 such as, for example, running simulations, deciding on control actions to be taken, causing the digital twin 220 to learn from observations, etc. To effect such actions, the solver engine 250 may execute various recipes 252 (which may be stored in the database 226 or elsewhere) that define a sequence of steps to be performed by separate step engines 260. Accordingly, the solver engine 250 may identify a recipe to be executed (e.g., based on manual selection of a recipe 252 for execution by a user, invocation of a recipe 252 by step engine 260, identification by the step of another recipe 252 under execution, a scheduled time for a recipe 252, a timer elapsing since the past execution of the recipe 252, or the occurrence of some trigger event associated with the recipe 252). The solver engine 250 may then begin to “walk through” the steps of the recipe 252, identifying an appropriate step engine 260 to perform the step, issuing the step to that step engine 260, receiving the result after the step engine 260 has completed its work, and then move on to the next step of the recipe 252. In some embodiments, the solver engine 250 may itself be adapted to perform some steps. The solver engine 250 may then iterate on this process until it reaches the end of the recipe 252.

In some cases, the solver engine 250 may decide that one or more steps of a recipe 252 are to be outsourced to another controller 292. For example, the recipe 252 itself may specify that a step is to be performed by another controller 292, the solver engine 250 may determine that local processing capacity is not sufficient to perform a step, or the solver engine may encounter multiple parallel steps in a recipe 252 and decide to perform only one or a subset locally while outsourcing the rest.

The step engines 260 may include a number of varying functions that can be relied on by the recipes 252 and solver engine 250 to perform various steps of a larger task. As shown, the step engines 260 include a simulator 262, a control pathfinder 264, and inference kit 266, a learning engine 268, and one or more additional step engines 270. It will be apparent that fewer, additional, or different step engines 270 may be included depending on the functions to be performed by the controller 210 (e.g., as may be defined in the recipes 252) and as appropriate to adapting the controller 210 for use in different applications.

The simulator 262 may be configured to simulate the behavior of the system 100 into the future or under alternative/hypothesis conditions. To accomplish such a simulation, the simulator 262 may execute a sequence of timesteps (e.g., simulating the state of the digital twin 220 a minute into the future at a time) until the future time is reached and state can be read from the digital twin 220. For example, to simulate the temperature of a zone one hour into the future, the simulator 262 may propagate heat from all heat sources through the digital twin 220 one minute at a time, sixty times, and then read the temperature of the zone from the digital twin 220. The use of the digital twin 220 to perform such simulations will be explained in greater detail below. In various embodiments, the simulator 262 may actually encompass multiple more specific simulator step engines. For example, the simulator 262 may include separate simulators for simulating state of the building, operating of equipment, occupancy of different zones of the building, and the impact of weather or other external factors on the state of the system 100. The simulator 262 (or other step engines 260) may make use of the digital twin in different manners. In some cases, the simulator 262 may retrieve a precompiled (e.g., at the time of initial digital twin creation) digital twin 220, place it in memory, populate relevant data into it, and use the data that is produced as simulation output. In other cases, the simulator 262 may alter portions of the digital twin 220 description at the time of simulation (e.g., adding or removing equipment, or changing equipment parameters), compile the digital twin at that point in time, place the newly-compiled twin in memory, and then run its simulation. Thus, the digital twin 220 may include both a data description of the systems being modeled as well as compiled and functional versions of that data description.

The control pathfinder 264 may be configured to identify, using the digital twin 220, one or more control actions to be performed be the field devices 296 to reach a desired state. For example, the control pathfinder 264 may analyze multiple possible candidate control schemes against the digital twin 220 to determine which candidate control scheme best produces the desired state in the digital twin 220 and then write the control actions from that scheme to the database 226 for the field device manager 230 to act on. In some embodiments, the control pathfinder 264 may leverage the simulator 262 to perform its task (and likewise, step engines 260 may in some embodiments generally invoke each other when useful to the performance of their task).

In other embodiments, the control pathfinder 264 may utilize auto-differentiation and gradient descent to identify an appropriate control scheme to reach a desired state in the digital twin 220. As will be explained in greater detail below, through auto-differentiation, the digital twin 220 may be established as omnidirectional; that is, while activation functions may be defined or learned in a forward direction, their partial derivatives may be used to define “activation functions” in the reverse direction, thereby enabling traversal of the digital twin 220 in any direction and along any path desired. When paired with differentiable programming to define the digital twin 220 (particularly, its activation functions), such partial derivatives may be made available in the digital twin 220 with little-to-no additional compute cost. From here, the control pathfinder 264 may generate a cost function on the digital twin 220 that relates a set of input variables (e.g., possible control variables) to a cost—the distance between the predicted state values and the desired state values. The control pathfinder 264 may then employ gradient descent to identify a control scheme likely to produce the desired state in the environment 110 (or a state acceptably close to the desired state).

Various additional, alternative, or modified methods may be used by the control pathfinder 264 to locate a control path. For example, in some embodiments, the control pathfinder 264 may employ multiple gradient descent agents (e.g., as a Self-Organizing Migrating Algorithm or SOMA) to improve the likelihood of locating a global minimum of the cost function, rather than a local minimum representing a sub-optimal solution control scheme. In some embodiments, a simpler neural network trained against the digital twin 220 for a reduced problem may be used by the control pathfinder 264 to find a control scheme quickly which is then tested and refined against the digital twin 220 or written directly to the database so that the field devices 296 may be controlled immediately. In some embodiments, the control pathfinder 264 may employ more than one of these and other approaches in an ensemble or adversarial approach to find optimal control schemes. Various additional techniques that may be used in implementing a simulator 262, control pathfinder 264, other step engines 260, or other aspects of the controller 210 according to some embodiments may be described in U.S. Pat. Nos. 10,705,492; 10,921,760; U.S. patent application publication numbers 2021/0381712; 2021/0383042; and 2021/0383219, the entire disclosures of which are hereby incorporated herein by reference.

The inference kit 266 may be configured to draw information from the digital twin 220 for use in driving decisions. As such, the inference kit 266 may enable reading of values from the digital twin 220 and transformation of such values into derived properties and other values (e.g., reading heat and humidity values and sending them through a transformation to produce a comfort value). In various embodiments, the inference kit 266 may provide more advanced inferencing such as performing sensor fusion and defining “virtual sensors” to enable simulation of additional state values at locations where there are not sensors in the real world system 100 from which to draw information. Various techniques for implementing an inference kit 266 according to some embodiments may be disclosed in U.S. patent application publication number 2021/0383236, the entire disclosure of which is hereby incorporated herein by reference.

The learning engine 268 may be configured to train machine learning models for the benefit of the controller 210. For example, in various embodiments, the digital twin 220 itself is trainable. As such, the learning engine 268 may periodically use one or more training examples and machine learning approaches (such as supervised learning and gradient descent) to train the digital twin's 220 activation functions to better model the observed real world system. Such training examples may be drawn from the database 226 (e.g., from sensor data placed there by the field device manager 230 or additional controllers 292). In some embodiments, the learning engine 268 may train additional neural networks, deep learning networks, or other machine learning models based on the simulations (e.g., as may be run by the simulator 262). As such, the learning engine 268 may include a training archivist that captures simulated cases during execution of a recipe 252 and stores them as training examples in the database 226. The learning engine 268 may later used these training examples to train these simple models for later use. Thus, in various embodiments, the learning engine 268 trains the digital twin 220 based on real world observed data and then trains simple models based on the operation of the digital twin 220. Various additional techniques for implementing a learning engine 268 according to some embodiments may be disclosed in U.S. patent application publication number 2021/0383041, the entire disclosure of which is hereby incorporated by reference herein.

As noted, the step engines 260 may include additional step engines 270 as appropriate to the recipes 252 and application of the controller 210. For example, the additional step engines 270 may include an ontological reasoner (which may use various techniques to simplify the digital twin 220 to only those portions relevant to a particular task, thereby reducing processing resources needed), an occupant process (which may take into account occupant comfort needs or desires to guide the determination of a desired state in a system), a weather process (which may make or otherwise obtain weather forecasts), and other engines. Various additional step engines 270 that may be useful will be apparent. Various additional techniques for implementing such additional step engines 270 according to some embodiments may be described in in U.S. Pat. Nos. 10,969,133; and 11,553,618, the entire disclosures of which are hereby incorporated herein by reference.

It will be apparent that, while particular components are shown connected to one another, this may be a simplification in some regards. For example, components that are not shown as connected may nonetheless interact. For example, the user interface 216 may provide a user with some access to the recipes 252 or field device manage 230. Furthermore, in various embodiments, additional components may be included and some illustrated components may be omitted. In various embodiments, various components may be implemented in hardware, software, or a combination thereof. For example, the communications interface 212 may be a combination of communications protocol software, wired terminals, a radio transmitter/receiver, and other electronics supporting the functions thereof. As another example, the solver engine 250 and step engines 260 may be implemented as software running on a processor (not shown) of the controller 210, while the digital twin 220 may be a data structure stored in the database 226 which, in turn, may include memory chips and software for managing database organization and access. Various other implementation details will be apparent and various techniques for implementing a controller 210 and various components thereof according to some embodiments may be described in U.S. patent application publication numbers 2022/0066432; 2022/0066722; U.S. provisional patent applications 62/518,497; 62/704,976; and 63/070,460 the entire disclosures of which are hereby incorporated herein by reference.

It will be further apparent that various techniques described herein may be utilized in contexts outside of controller devices. For example, various techniques may be adapted to project planning tools, report generation, reporting dashboards, simulation software, modeling software, computer aided drafting (CAD) tools, predictive maintenance, performance optimization tools, or other applications. Various modifications for adaptation of such techniques to other applications and domains will be apparent.

FIG. 3 illustrates an example digital twin 300 for use in various embodiments. The digital twin 300 may correspond, for example, to the digital twin 220, the environment twin 222, or the controlled system twin 224 of FIG. 2. As shown, the digital twin 300 includes a number of nodes 310, 320, 330, 340, 350, 360 connected to each other via edges. As such, the digital twin 300 may be arranged as a graph, such as a neural network. In various alternative embodiments, other arrangements may be used. Further, while the digital twin 300 may reside in storage as a graph type data structure, it will be understood that various alternative data structures may be used for the storage of a digital twin 300 as described herein. The nodes 310, 320, 330, 340, 350, 360 may correspond, for example, to aspects of the environment 110 such as HVAC zones, walls, windows, external forces (such as weather); aspects of the sensor system 130 such as individual sensors; aspects of the controllable system 120 such as controllable HVAC equipment; virtual entities, such as HVAC zone subdivisions or virtual sensors that may be assigned values through sensor fusion; or other aspects that may be used in a simulation. The edges between the nodes 310, 320, 330, 340, 350, 360 may, then, represent some relationship between the system aspects represented by the nodes 310, 320, 330, 340, 350, 360; an edge may represent, for example, physical proximity or relative location, proximity or relative location within a control loop of a system, or another relationship.

According to various embodiments, the digital twin 300 is a heterogenous neural network. Typical neural networks are formed of multiple layers of neurons interconnected to each other, each starting with the same activation function. Through training, each neuron's activation function is weighted with learned coefficients such that, in concert, the neurons cooperate to perform a function. The example digital twin 300, on the other hand, may include a set of activation functions 313, 325, 343, 345, 363, 365 that are, even before any training or learning, differentiated from each other, i.e., heterogenous. In various embodiments, the activation functions 313, 325, 343, 345, 363, 365 may be assigned based on domain knowledge related to the system being modeled. For example, the activation functions 313, 325, 343, 345, 363, 365 may include appropriate heat transfer functions for simulating the propagation of heat through a physical environment (such as function describing the radiation of heat from or through a wall of particular material and dimensions to a zone of particular dimensions). As another example, activation functions 313, 325, 343, 345, 363, 365 may include functions for modeling the operation of an HVAC system at a mathematical level (e.g., modeling the flow of fluid through a hydronic heating system and the fluid's gathering and subsequent dissipation of heat energy). Such functions may be referred to as “behaviors” assigned to the nodes 310, 320, 330, 340, 350, 360. In some embodiments, each of the activation functions 313, 325, 343, 345, 363, 365 may in fact include multiple separate functions; such an implementation may be useful when more than one aspect of a system may be modeled from node-to-node. For example, each of the activation functions 313, 325, 343, 345, 363, 365 may include a first activation function for modeling heat propagation and a second activation function for modeling humidity propagation. In some embodiments, these diverse activation functions along a single edge may be defined in opposite directions. For example, a heat propagation function may be defined from node 310 to node 330, while a humidity propagation function may be defined from node 330 to node 310. In some embodiments, the diversity of activation functions may differ from edge to edge. For example, one activation function 313 may include only a heat propagation function, another activation function 343 may include only a humidity propagation function, and yet another activation function 363 may include both a heat propagation function and a humidity propagation function.

According to various embodiments, the digital twin 300 is an omnidirectional neural network. Typical neural networks are unidirectional-they include an input layer of neurons that activate one or more hidden layers of neurons, which then activate an output layer of neurons. In use, typical neural networks use a feed-forward algorithm where information only flows from input to output, and not in any other direction. Even in deep neural networks, where other paths including cycles may be used (as in a recurrent neural network), the paths through the neural network are defined and limited. The example digital twin 300, on the other hand, may include activation functions along both directions of each edge: the previously discussed “forward” activation functions 313, 325, 343, 345, 363, 365 (shown as solid arrows) as well as a set of “backward” activation functions 331, 334, 336, 352, 354, 356 (shown as dashed arrows).

In some embodiments, at least some of the backward activation functions 331, 334, 336, 352, 354, 356 may be defined in the same way as described for the forward activation functions 313, 325, 343, 345, 363, 365—based on domain knowledge. For example, while physics-based functions can be used to model heat transfer from a surface (e.g., a wall) to a fluid volume (e.g., an HVAC zone), similar physics-based functions may be used to model heat transfer from the fluid volume to the surface. In some embodiments, some or all of the backward activation functions 331, 334, 336, 352, 354, 356 are derived using automatic differentiation techniques. Specifically, according to some embodiments, reverse mode automatic differentiation is used to compute the partial derivative of a forward activation function 313, 325, 343, 345, 363, 365 in the reverse direction. This partial derivative may then be used to traverse the graph in the opposite direction of that forward activation function 313, 325, 343, 345, 363, 365. Thus, for example, while the forward activation function 313 may be defined based on domain knowledge and allow traversal (e.g., state propagation as part of a simulation) from node 310 to node 330 in linear space, the reverse activation function 331 may be defined as a partial derivative computed from that forward activation function 313 and may allow traversal from node 330 to 310 in the derivative space. In this manner, traversal from any one node to any other node is enabled—for example, the graph may be traversed (e.g. state may be propagated) from node 340 to node 310, first through a forward activation function 343, through node 330, then through a backward activation function 331. By forming the digital twin as an omnidirectional neural network, its utility is greatly expanded; rather than being tuned for one particular task, it can be traversed in any direction to simulate different system behaviors of interest and may be “asked” many different questions.

According to various embodiments, the digital twin is an ontological neural network. In typical neural networks, individual neurons do not represent anything in particular; they simply form the mathematical sequence of functions that will be used (after training) to answer a particular question. Further, while in deep neural networks, neurons are grouped together to provide higher functionality (e.g. recurrent neural networks and convolutional neural networks), these groupings do not represent anything other than the specific functions they perform; i.e., they remain simply a sequence of operations to be performed.

The example digital twin 300, on the other hand, may ascribe meaning to each of the nodes 310, 320, 330, 340, 350, 360 and edges therebetween by way of an ontology. For example, the ontology may define each of the concepts relevant to a particular system being modeled by the digital twin 300 such that each node or connection can be labeled according to its meaning, purpose, or role in the system. In some embodiments, the ontology may be specific to the application (e.g., including specific entries for each of the various HVAC equipment, sensors, and building structures to be modeled), while in others, the ontology may be generalized in some respects. For example, rather than defining specific equipment, the ontology may define generalized “actors” (e.g., the specific actor types for ascribing to nodes) that operate on “quanta” (e.g., the ontology may define fluid, thermal, mechanical, and other quanta for propagation through the model) passing through the system. Quanta are the packets of information that are shared between actors, allowing for appropriate interactions to take place between parts of a given system. Additional aspects of the ontology may allow for definition of behaviors and properties for the actors and quanta that serve to account for the relevant specifics of the object or entity being modeled.

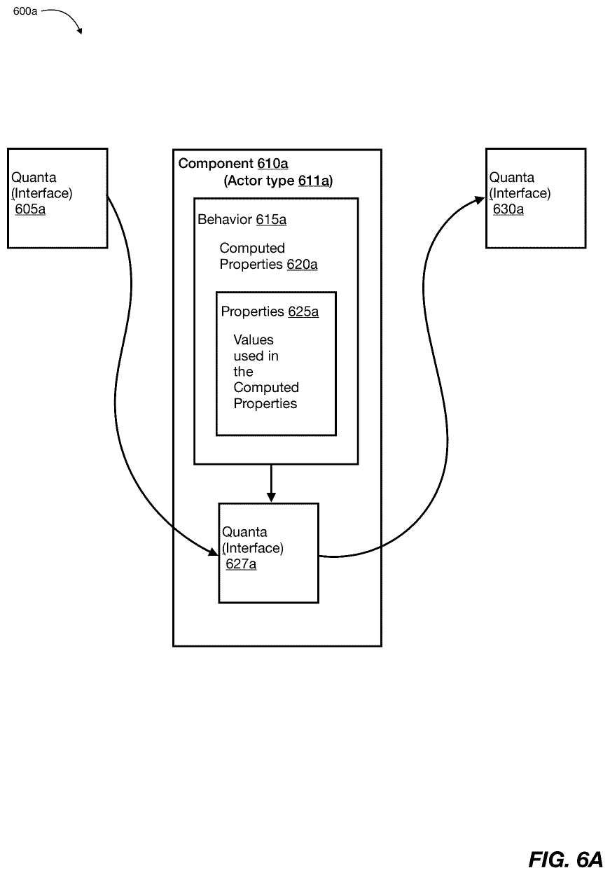

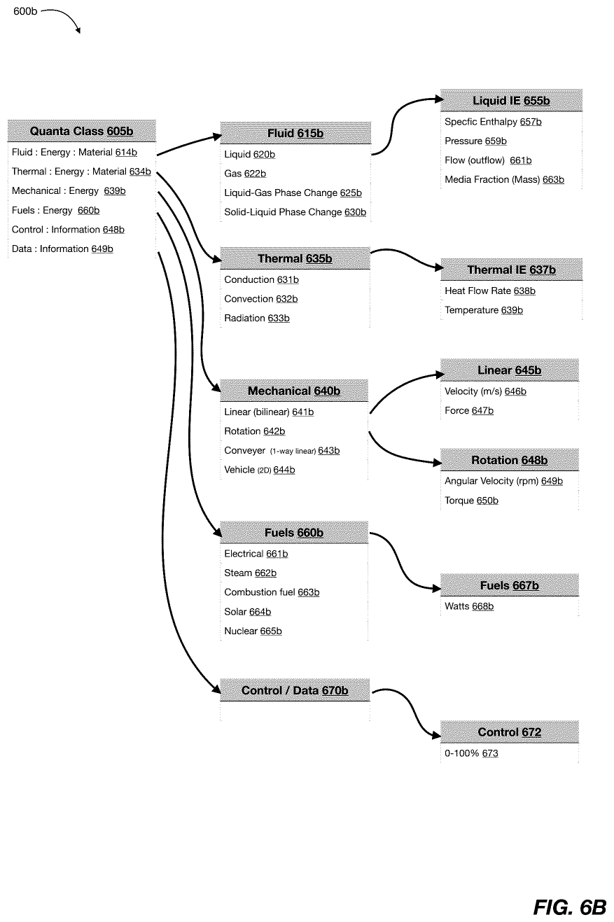

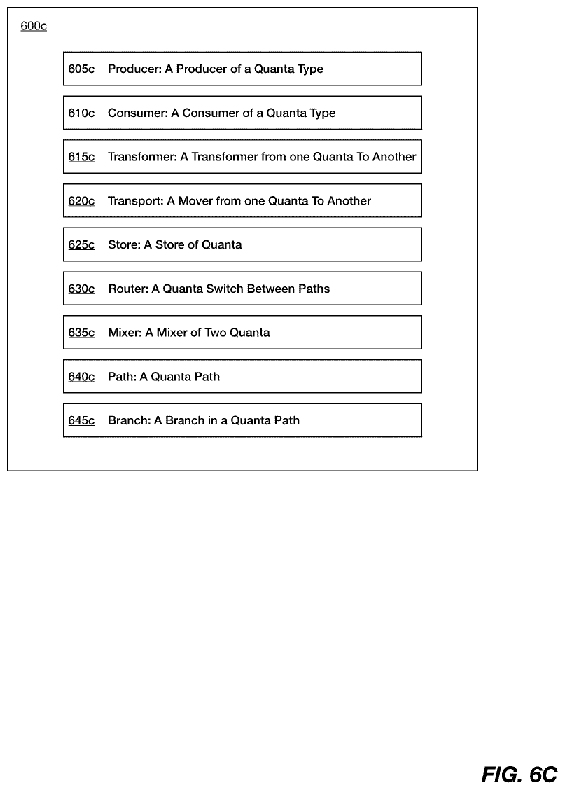

FIG. 6B describes some relationships among quanta. Possible quanta classes (at the top of the hierarchy) are divided up into reasonable groupings. Quanta interact with the components through interface elements which then have interface elements that interact with the behaviors within the components to modify the quanta during a simulation. In embodiments, some top-level quanta classes 605b are fluid 614b, thermal 634b, mechanical 639b, fuels, 660b control and data. Quanta 600b are packets of information that are shared between components 610a, allowing for appropriate interactions to take place between parts of the system. Quanta have a quasi-taxonomic relationship in that different sorts of quanta may have different hierarchical relationships. The quanta examples shown with reference to FIG. 6B are just that, some possibilities of some quanta. It should be understood, as within the rest of the examples given herein, the quanta shown may have more or less hierarchical levels than shown, different interface elements, etc.

Behaviors 615a in components 610a have properties 625a, similar to variables. These properties 625a interact with matching properties in the quanta allowing the behaviors to modify the quanta. For example, the quanta class 605b subdivision fluid 614b, 615b has the further subdivision liquid 620b. The liquid quanta 620b, may have interface elements 655b with properties, such as specific enthalpy 657b, pressure 659b, Flow (outflow) 661b, and media fraction (Mass) 663b. These interface properties may be thought of as writable quantities that are calculated once per timestep. The other fluid quanta (e.g., gas 622b. liquid-gas phase change 625b, solid-liquid phase change 630b) may have similar or different quanta interfaces. These interface properties—e.g., specific enthalpy 657b, pressure 659b, flow 681b, mass 663b—may have matching properties 625a within a component 610a. During a simulation these matching interface/properties may then interact with the quanta to change state of the quanta.

In terms of thermal energy systems (e.g., fluid, thermal, fuels, etc.), quanta may be defined as mediums of thermal exchange such as fluids, gases, or types of heat transfer. In terms of information systems and control, quanta may take the form of mechanical or control quanta. Each of these may have subgroups. For example, thermal quanta 634b may have subgroups 635b, such as conduction 631b convection 632b, and radiation 633b. These subgroups may share interface elements. For example, the thermal quanta may have as interface elements 637b heat flow rate 638b and temperature 639b. As a further example, mechanical data 639b may be further subdivided into the mechanical quanta 640 linear 641b, rotation 642b, conveyor (one-way) 643b, and vehicle (two-dimensional, e.g., can travel along an x-y axis) 644b quanta. These mechanical quanta may each have their own quanta interfaces, or share interfaces. As an example, the linear quanta 641b may have velocity 646b and force 647b as interface elements, while rotation 648b may have angular velocity 649b and torque 650b.

The fuel quanta type 660b may be thought more generally as energy. Among these fuel energy types 645b may be electrical 661b, steam 662b, combustion fuel 663b, solar 664b, nuclear 665b, etc. The fuels interface elements 667b may be a measure of energy, such as watts 668b. Control data 670b may include the control or controls state 673. It should be noted that the specifics of the quanta taxonomy may depend on the nature of the underlying quanta, and how the various quanta and their interfaces map onto the behaviors 615a of the components 610a . . . . Other types of quanta may be defined for other relevant applications. These taxonomic divisions of quanta may be designed as aids to group information necessary to accurately model the quanta within the components 610a, and the groupings, subgrouping, and interfaces are expected to make sense for a specific system. What has been shown here is just one taxonomy possible among many.

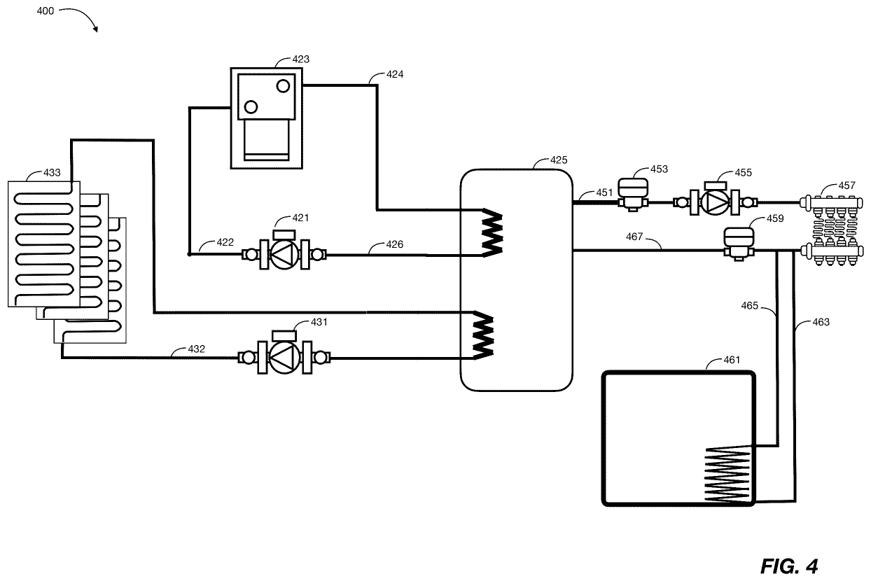

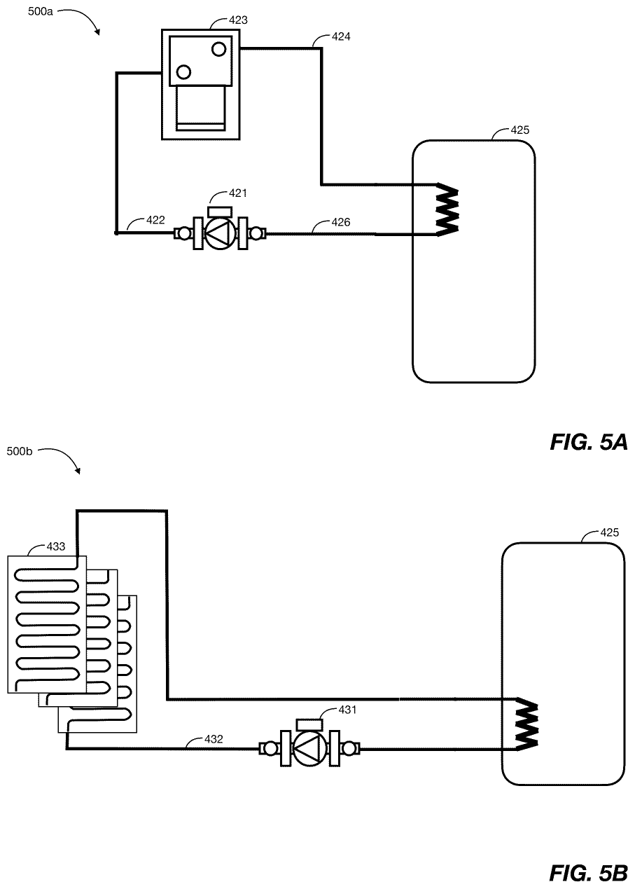

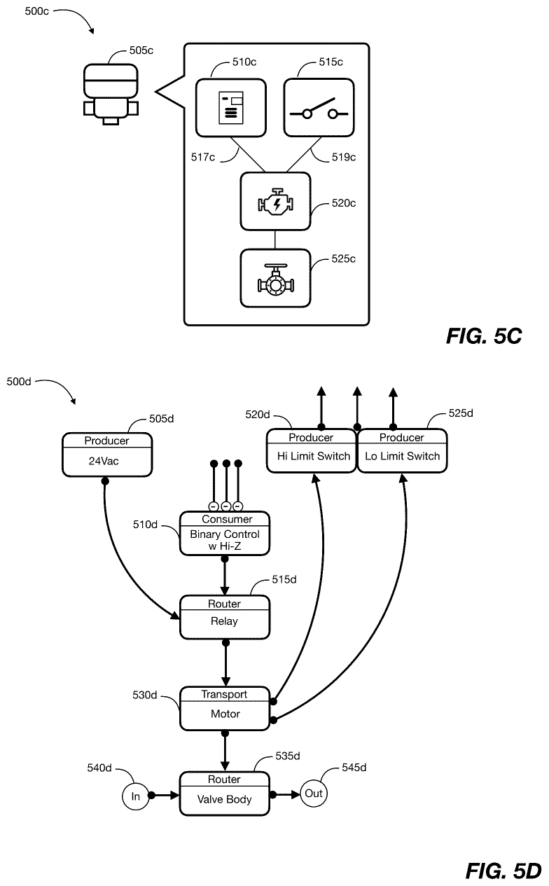

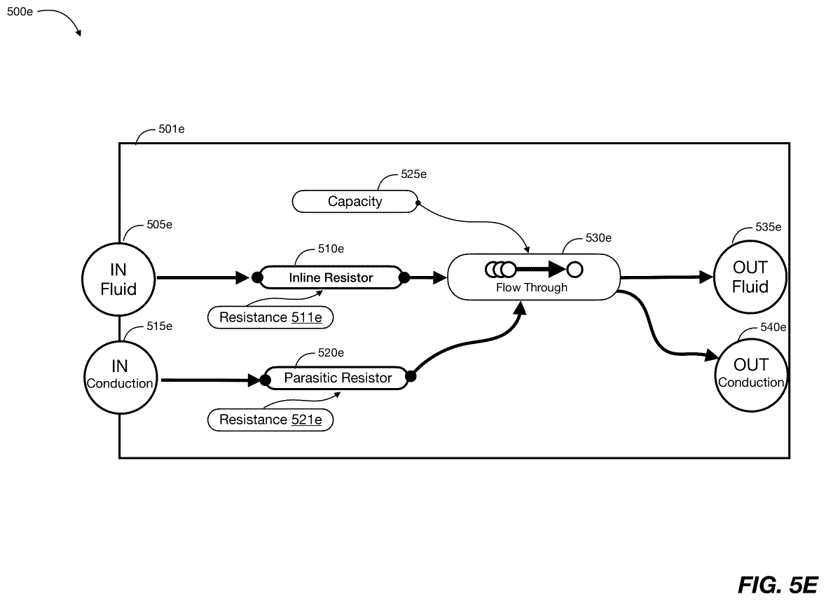

FIG. 6C at 600c describes some possible actors. Systems are broken down into subsystems, which are themselves broken down into equipment and connections, as described with reference to FIGS. 4, 5A, and 5B. Equipment is further broken down into components, as described with reference to FIG. 5C. Components are broken down into actors, as described with reference to FIG. 5D. Brief descriptions of some actor types follow. Actor type 605c is type Producer, which produces a quantum type. Actor type Consumer 610c consumes a quantum type, such as a radiator which may consume thermal quanta, Actor type Transformer 615c transforms one type of quantum into another, such as a heat exchanger. Actor type Transport 620c moves quanta. For example, pumps, conveyor belts, and fans are all transports. Actor type Store 625c is a store of quanta, such as a tank. Actor type Router 630c switches quanta between paths. Actor type Mixer 635c mixes two quanta. Actor type Path 640c is a path for quanta to move through, such as a pipe. Actor type Branch 645c indicates a branch in a quantum path that may send some sorts of quanta down a different path. These actor types define much about the nature of the component that is being so described, allowing the components to understand their functions within the system.

With actors (e.g., equipment, etc.) that understand both the nature of the material they trade in (quanta) and how their own behaviors transform those materials, they may be able to automatically determine whether connections with other equipment actors make sense. This may create a compute graph that can verify its own validity. When expressed in these quantum terms described, the fundamental physics of an assembly may provide a built-in sanity check that the assembly is configured correctly.

Actors define the job a certain object has within the system. Behaviors define what an object is capable of doing. The interplay between the two determines that objects with certain behaviors are matched to the correct roles in the system. Behaviors are characterized, in most instances, by physical equations within the activation functions, e.g., 313, 325, 343, 345, 363, 365, which then in turn shape the quanta that can be shared between objects. When the systems so created does not know all of the behaviors prior to implementation, it may be able to learn by observing actual behaviors in a system that is being modeled by the digital twin to make the digital twin much more accurate.

The above techniques, alone or in combination, may enable a fully-featured and robust digital twin 300, suitable for many purposes including system simulation and control path finding. The digital twin 300 may be computable and trainable like a neural network, queryable like a database, introspectable like a semantic graph, and callable like an API. As described above, the digital twin 300 may be traversed in any direction by application of activation functions along each edge. Thus, just like a typical feedforward neural network, information can be propagated from input node(s) to output node(s). The difference is that the input and output nodes may be specifically selected on the digital twin 300 based on the question being asked, and may differ from question to question. In some embodiments, the computation may occur iteratively over a sequence of timesteps to simulate over a period of time. For example, the digital twin 300 and activation functions may be set at a particular timestep (e.g., 1 minute), such that each propagation of state simulates the changes that occur over that period of time. Thus, to simulate longer period of time or point in time further in the future (e.g., one minute), the same computation may be performed until a number of timesteps equaling the period of time have been simulated (e.g., 60 one second timesteps to simulate a full minute). The relevant state over time may be captured after each iteration to produce a value curve (e.g., the predicted temperature curve at node 310 over the course of an hour) or a single value may be read after the iteration is complete (e.g., the predicted temperature at node 310 after an hour has passed). The digital twin 300 may also be inferenceable by, for example, attaching additional nodes at particular locations such that they obtain information during computation that can then be read as output (or as an intermediate value as described below).

While the forward activation functions 313, 325, 343, 345, 363, 365 may be initially set based on domain knowledge, in some embodiments training data along with a training algorithm may be used to further tune the forward activation functions 313, 325, 343, 345, 363, 365 or the backward activation functions 331, 334, 336, 352, 354, 356 to better model the real world systems represented (e.g., to account for unanticipated deviations from the plans such as gaps in venting or variance in equipment efficiency) or adapt to changes in the real world system over time (e.g., to account for equipment degradation, replacement of equipment, remodeling, opening a window, etc.).

Training may occur before active deployment of the digital twin 300 (e.g., in a lab setting based on a generic training data set) or as a learning process when the digital twin 300 has been deployed for the system it will model. To create training data for active-deployment learning, the controller 210 may observe the data made available from the real-world system being modeled (e.g., as may be provided by a sensor system 140) and log this information as a ground truth for use in training examples. To train the digital twin 300, the controller 210 may use any of various optimization or supervised learning techniques, such as a gradient descent algorithm that tunes coefficients associated with the forward activation functions 313, 325, 343, 345, 363, 365 or the backward activation functions 331, 334, 336, 352, 354, 356. The training may occur from time to time, on a scheduled basis, after gathering of a set of new training data of a particular size, in response to determining that one or more nodes or the entire system is not performing adequately (e.g., an error associated with one or more nodes 310, 320, 330, 340, 350, 360 passed a threshold or passes that threshold for a particular duration of time), in response to manual request from a user, or based on any other trigger. In this way, the digital twin 300 may be adapted to better adapt its operation to the real world operation of the systems it models, both initially and over the lifetime of its deployment, by tacking itself to the observed operation of those systems.

The digital twin 300 may be introspectable. That is, the state, behaviors, and properties of the nodes 310, 320, 330, 340, 350, 360 may be read by another program or a user. This functionality is facilitated by association of each node 310, 320, 330, 340, 350, 360 to an aspect of the system being modeled. Unlike typical neural networks where, due to the fact that neurons don't represent anything particularly the internal values are largely meaningless (or perhaps exceedingly difficult or impossible to ascribe human meaning), the internal values of the nodes 310, 320, 330, 340, 350, 360 can easily be interpreted. If an internal “temperature” property is read from node 310, it can be interpreted as the anticipated temperature of the system aspect associated with that node 310.

Through attachment of a semantic ontology, as described above, the introspectability can be extended to make the digital twin 300 queryable. That is, ontology can be used as a query language usable to specify what information is desired to be read from the digital twin 300. For example, a query may be constructed to “read all temperatures from zones having a volume larger than 200 square feet and an occupancy of at least 1.” A process for querying the digital twin 300 may then be able to locate all nodes 310, 320, 330, 340, 350, 360 representing zones that have properties matching the volume and occupancy criteria, and then read out the temperature properties of each. The digital twin 300 may then additionally be callable like an API through such processes. With the ability to query and inference, canned transactions can be generated and made available to other processes that aren't designed to be familiar with the inner workings of the digital twin 300. For example, an “average zone temperature” API function could be defined and made available for other elements of the controller or even external devices to make use of. In some embodiments, further transformation of the data could be baked into such canned functions. For example, in some embodiments, the digital twin 300 itself may not itself keep track of a “comfort” value, which may defined using various approaches such as the Fanger thermal comfort model. Instead, e.g., a “zone comfort” API function may be defined that extracts the relevant properties (such as temperature and humidity) from a specified zone node, computes the comfort according to the desired equation, and provides the response to the calling process or entity.

It will be appreciated that the digital twin 300 is merely an example of a possible embodiment and that many variations may be employed. In some embodiments, the number and arrangements of the nodes 310, 320, 330, 340, 350, 360 and edges therebetween may be different, either based on the controller implementation or based on the system being modeled by each deployment of the controller. For example, a controller deployed in one building may have a digital twin 300 organized one way to reflect that building and its systems while a controller deployed in a different building may have a digital twin 300 organized in an entirely different way because the building and its systems are different from the first building and therefore dictate a different model. Further, various embodiments of the techniques described herein may use alternative types of digital twins. For example, in some embodiments, the digital twin 300 may not be organized as a neural network and may, instead, be arranged as another type of model for one or more components of the system 100. In some such embodiments, the digital twin 300 may be a database or other data structure that simply stores descriptions of the system aspects, environmental features, or devices being modeled, such that other software has access to data representative of the real world objects and entities, or their respective arrangements, as the software performs its functions.

FIG. 4 illustrates a sample system 400 that is to be simulated. It includes a pump 421 that, using a pipe 422, which feeds into a boiler 423, which, in turn, feeds into a storage tank 425. This system also includes another pump 431 which uses a pipe 432 to feed into radiant heaters 433, which then feed into the same storage tank 425. Continuing, a pipe 451 feeds from the storage tank 425 to a two-way valve 453, which feeds into a pump 455, which feeds into a linker/manifold 457. That manifold feeds into both another two-way valve and then into the storage tank 425. Another path from the linker/manifold runs through pipe 463 to a heating tank 461, and then from there from pipe 465, through the two-way valve 459, and then through the shared pipe 467 back to the storage tank. This system may then be broken down into independent subsystems-discombobulation. As large systems have mind-(and computer-) numbing complexity, breaking such a complex system down into subsystems may be required to be able to create a simulation that runs in some reasonable time. This allows, for example, a heating problem to be surgically dissected from a large system by ignoring the cooling system, etc. Example of subsystems that have been broken out of the system in FIG. 4 are shown in FIG. 5A at 500a and 5B at 500b. Various techniques for generating subsystems from a full system according to various embodiments, may be described in U.S. Pat. No. 10,708,078; the entire disclosure of which is hereby incorporated herein by reference. In some embodiments, a single timestep will be determined for all the subsystems. In some embodiments of timestep creation as described herein, different size timesteps may be created for separate subsystems. So, for example, a separate timestep size may be optimal for subsystem 5A, with a separate optimal timestep size for subsystem 5B. Both of those subsystems may have separate timesteps created for them, and, during simulation, may run (concurrently, sequentially, some other way) with those separate timesteps.

FIG. 5C at 500c illustrates how components are related to equipment. Equipment, such as the pumps 421, 431, pipes 424, 426, 463, 465, valves 453, 459 can be more fully characterized by breaking down the equipment into their components. In the illustrative example, a two-way valve 505c is further broken down into an interface 510c, two limit switches (both grouped into 515c), a motor 520c, and the valve 525c itself. The connections between the components are indicated by lines, e.g., 517c, such that the interface component 510c and the limit switches 519c can be seen that they are connected to the motor 520c.

FIG. 5D at 500d illustrates an example of how the components are broken down into quantum nodes with actor types and connections. The nodes may be the same or similar as the quantum nodes 310, 320, 330, 340, 350, 360 as discussed with reference to FIG. 3. The actions discussed with FIG. 3 may be performed on the nodes described here. Some components will be broken down into multiple nodes, while some components can be effectively modeled by a single node. The connections between the actors indicate flow between the nodes. In the illustrative example, the interface 510c is further broken down into three nodes: a binary control 510d consumer actor, a 24Vac power source 505d producer actor, and a router 515d relay actor. The limit switches 515c are each represented as producers; a hi limit switch 520d and a lo limit switch 525d. Each of these switches receives (quantum data) input from a motor 530d of type transport, which in turn sends quantum power to the valve body, of actor type as a router 535d. The valve body 535d has an input 540d and an output 545d, where liquid quanta will enter and exit. Looking at the specific functions of the The 24Vac produces quanta type energy that is sent to the relay 515d, which routes the energy quanta to the (112) Nodes are further categorized a actor type, as discussed generally with reference to FIG. 6A. As has been mentioned, actors define the job a certain object has within a system, such as producer, transport, etc. Behaviors define what an object is capable of doing. Behaviors are characterized, in some embodiments, by physical equations, which modify the quanta that is being shared between nodes. These physical equations then modify the quanta as it moves through the simulation. Behaviors have properties. The behavior may be a set of equations; the properties may then be the values of the variables in the equation. Properties give rise to computed properties. While in a perfect world, sensors would monitor every property to be tracked, in practice this is impractical and too expensive. It would also lead to too much data to effectively process. By using the behaviors and known properties, physics can be used to infer what values most likely exist for unknown properties—the computed properties.

FIG. 6A at 600a illustrates a brief overview of the internal nature of a specific actor type of a component, e.g., the valve body 535d. Briefly, the hierarchy is that a system includes equipment, and equipment is composed of components. The components may further be broken down into nodes. These nodes, possessing a specific actor type 610a, in turn, accept quanta 605a as input, which corresponds to 540d “In”. The quanta may be moved into the component 627a (e.g., the valve body 535d), where it might be modified by applying values in the quanta interface 605a to the equivalent quanta interface 627a in the component 610a. Some quanta types and some of their interfaces are discussed with more detail with reference to FIG. 6B.

The amount of quanta that is being modified may depend on the size of a timestep. The modified quanta may then be moved to an out location 630a (e.g., 545d, 931c), where it will be moved into the next node. A type of actor associated with the component defines certain aspects of the ontology of the represented device. For instance, if a node serves as a pump, it inherently acts as a transport entity within the system, and so is considered a transport actor. When assessing the nature of this transport actor, one may expect to find routers or similar nodes. Within each component 610a, the type of quanta 605a that will be acted on by the actor type of the component gives extra information corresponding to the interface of they type of quanta. For example, in cases involving liquid quanta, additional information exists regarding pressure and entropy, representing the concept of energy. More information about quanta types is discussed with relation to FIG. 6B.

The component 610a contains behaviors 615a. These behaviors may be thought of as computed properties 620a (often physics equations) that define the component's interaction with the quanta 605a. The quanta 605a enter a node—represented by the quanta 605a moving into the component internal quanta packet 627a—and then is modified by the behaviors 615a associated with the node. These behaviors possess a fundamental notion of action; for example, in the case of a resistor, its primary action is to modify the pressure of the quanta. The specific manner in which it alters the pressure is contingent upon properties associated with it. For example, in cases involving liquid quanta, additional information exists regarding pressure and enthalpy, representing the concept of energy, as well as temperature. The behaviors may modify a liquid quanta by, for example, altering its pressure, temperature, etc. These behaviors modify the quanta instantly. Properties 625a can be thought of as values that can be used in the equations 620a. These properties may be global, specific to the actor 610a, modified by the quanta 605a, etc. Properties may be dimensional in nature, encompassing attributes such as length. Some pieces of equipment are difficult to characterize universally into actor forms, and so must be characterized by the specific functions of the equipment. A resistor, for example, lacks an inherent ontology and can manifest in various forms. An in-line resistor, for instance, may function akin to friction, while another type of resistor, often referred to as parasitic resistance, might mimic the dissipation of heat into the environment. Each behavior encapsulates both an action and quanta, with certain behaviors being receptive to distinct types of quanta.

Behavior 615a, as noted, are described in terms of equations 620a that reside within the activation functions of the nodes, e.g., 505d, 520d, etc. These behaviors constitute the central computational elements in this framework. The activation functions within each behavior are designed to be inherently composable, meaning they can interlock seamlessly, resulting in a set of normalized behaviors. Ultimately, the information flows from one differentiable node to another. After identification, users may not be permitted to alter the fundamental equations governing the behaviors; their scope of influence may be limited to adjusting properties 625a within these core equations 620a. For instance, in the case of inline resistance, the core element remains fixed and inaccessible to user manipulation, while the user can only modify the resistance's magnitude, a property 625a. Moreover, there is no necessity to compute all behaviors continuously; the system can be adaptive, selectively computing only the crucial nodes.

Considering quanta 605a, generally, individual quanta types provide knowledge about how the quanta type interacts with components-which are modeled as nodes. For example, if the quanta that a node accepts is liquid, then the node knows that the liquid has certain interface items (as shown with reference to FIG. 6B at 655b) that will interact with the node. Quanta 605a passing through the node 627a triggers the behavior 615a as prescribed by the component 610a.

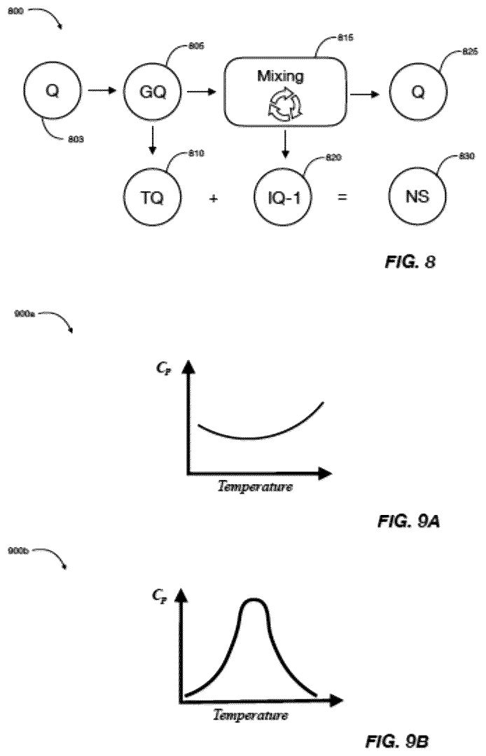

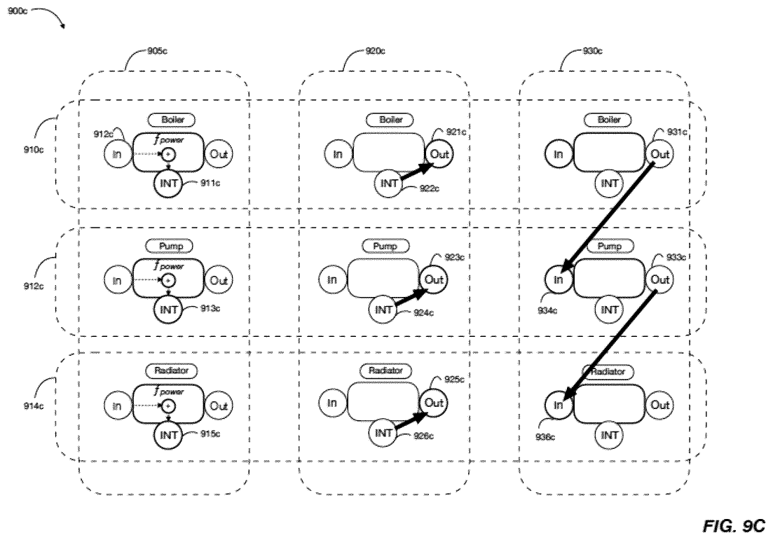

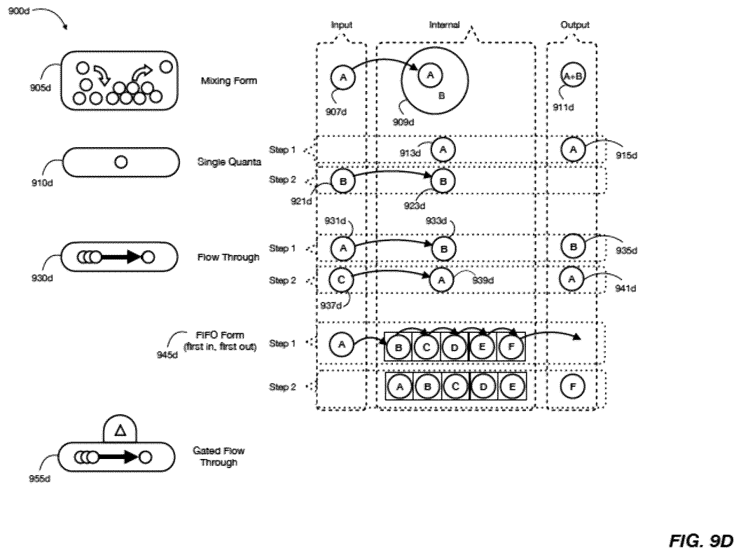

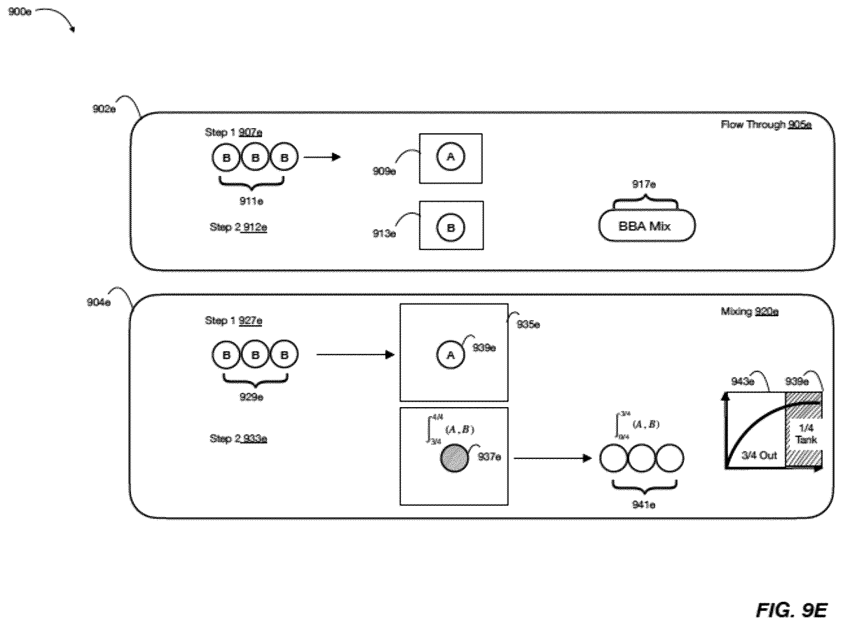

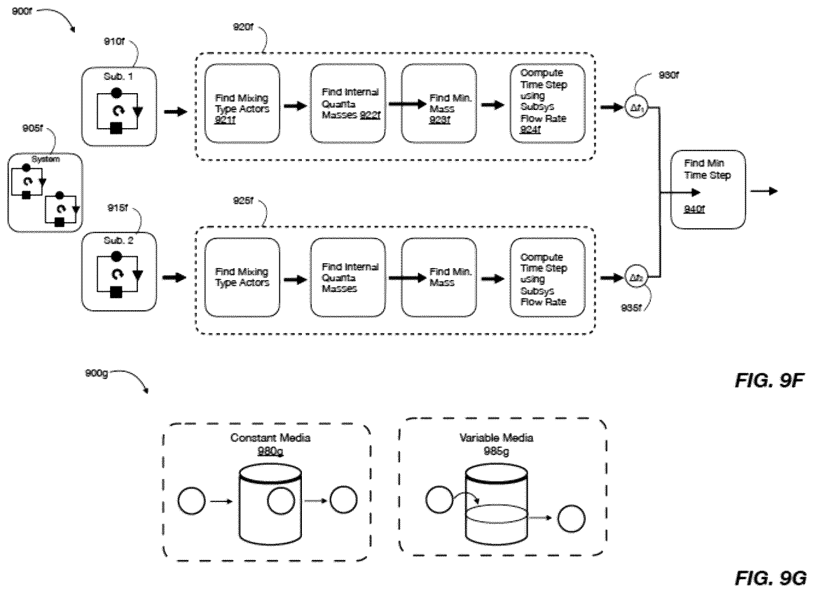

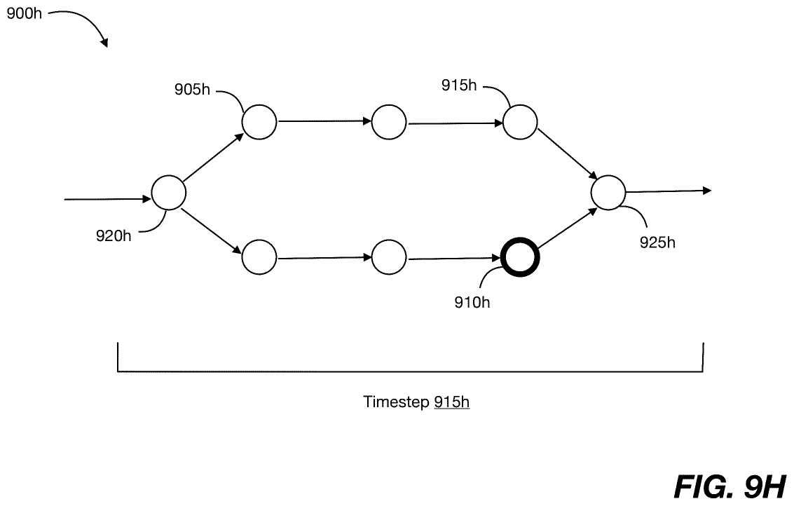

FIG. 6B illustrates an example quanta taxonomy, and some other information that may be associated with it. Quanta classes 605b describe different types of “things” that can interact and be changed by component nodes 610a with an actor type 611a. In some embodiments, these may be grouped into, e.g., fluids 615b, thermal 635b, mechanical 640b, fuels 645b, and control/data 650b. Fluids 615b can be further divided into e.g., liquid 620b, gas 622b, liquid-gas phase change 625b, and solid-liquid phase change 630b. Types of the fluid quanta 615b is especially interesting for accurate timestep creation. Phase changes (e.g., 625b, 630b) produce rapid changes in energy, as discussed with relation to FIG. 9B. These rapid energy differences must be handled very carefully to ensure that a simulation stays stable. When a phase change quanta will be active in a subsystem, then a special timestep equation may be used that uses the differential of the phase change to take into account the smaller timestep that should be used to capture the rapid energy change.

The features that take into account the quanta flow between nodes may be determined by the actor type and the quanta type using a behavior graph template. These templates can be determined beforehand. The flow of quanta between nodes is governed based, generally, on resistance. Knowing the resistance will give the flow, e.g., how the quanta changes between nodes. As the concept of resistance has been generalized to work across different forms of quanta, the generalized version of resistance can be used to determine the quantum behavior between nodes. Resistance, in some embodiments, may be calculated as inline resistance and as parasitic resistance. The inline resistance generally refers to resistance encountered by an electric current as it flows through a conductor along its intended path. This resistance arises due to the intrinsic properties of the material through which the current is passing. With the generalized definition of resistance described here, this idea has been expanded to resistance encountered by other types of quanta. For example, when boxes travel along a conveyor belt, there is friction as resistance. Fluid flowing through a pipe encounters resistance, partially due to the internal friction between the fluid particles and the walls of the pipe. Different combinations of actors and quanta have different calculations of resistance between nodes. Different actors may have different templates of behaviors.

As a specific example, FIG. 5E illustrates some aspects 500e of generalized quanta flow during a timestep 501e between certain node nodes that accept fluid quanta as a flow-through and then also output fluid quanta. As previously mentioned, in a system that is being modeled, the real-life components of quanta may be expected encounter actions that change their behavior between components which should be taken into account. These in-between actions, such as friction, resistance, etc., may be expected to be the same for most timesteps. As such, it may be calculated once at the beginning of the simulation, and then used during timesteps. In some embodiments, these actions may be calculated using templates. The answer to the calculation can then be used to determine change in quanta between different component nodes at each timestep. Different types of quanta and actor may have different templates to use for their flow behavior. As such, these templates may be decided by quanta-actor type, and then used during a simulation. Some types of resistance that may be encountered by liquid quanta will be discussed below; with the understanding that there are many types of resistance, each of which may be calculated at the beginning of a simulation. In some simulations, aspects of the digital twin may be modified in such a way that some of the quanta flow calculations, such as those calculations performed by templates, may need to be recalculated.

When quanta moves from component to component, the quanta may encounter resistance, such as the friction in a pipe as liquid moves through it. One type of resistance is known as “inline resistor 510e”. It can be determined by a number of variables, e.g., fluid viscosity, flow rate, temperature, pipe length, etc. These sorts of variables may be captured by the properties of the pipes, and as such, the inline resistance of fluid, can be determined. In some embodiments, the inline resistor is modeled as a behavior, the “inline resistor” 510e, which has a resistance property 511e associated with it. The inline resistance of other quanta can also be determined using similar principles. Aside from inline resistance, another sort of resistance affects actors that input and output fluid, known generally as “parasitic resistor 520e”. Parasitic resistance can be considered the “stray” or “unwanted” resistance that exists within a node due to the nature of the node 530e itself. It introduces additional resistance, hindering conduction 515e, or its equivalent. The amount of parasitic resistance is determined using a parasitic resistor behavior 520e that depends at least partially on the capacity 525e of the node itself and a resistance 521e property. In the example of fluid, a conduction parameter 515e is also used to determine parasitic resistance. State behavior of the flow-through component 530e changes the quanta energy. For reference, in this figure, representing a timestep, the component 530e stores the quanta, as shown with reference to FIG. 6A at 627a.

As another example, for a router actor with quanta type fuel, resistance includes inline resistance and counter force from a control input, which affects an output control, and inline resistance from the fuel input that affects the fuel output. Other combinations of actors and quanta have other calculations of resistance. In some embodiments, the inline resistance for a specific node can be determined once per simulation, as previously discussed, without a need to recalculate. With reference to timesteps, the inline resistance does not take the timestep into account. Rather, the same amount of resistance is used no matter the size of the timestep. In some embodiments, at a timestep, the inline resistance 510e is provided, then the flow through node 530e uses its behaviors, properties, and other resistance, such as parasitic resistance provided by the parasitic resistor 520e, to determine the flow-through behavior. This is state behavior, where the energy in the quanta is updated and stored during the timestep. Then, the transformed quanta is passed out to the next node as out fluid 535e and out conduction 540e.

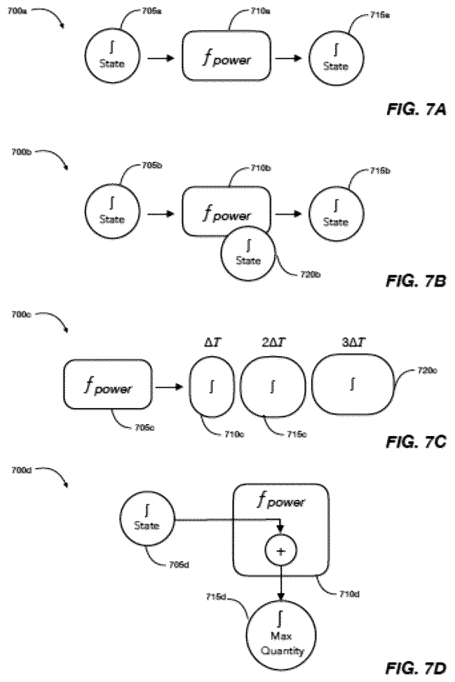

FIGS. 7A, 7B, 7C, and 7D illustrate aspects of nodes and quanta. FIG. 7A at 700a illustrates the principle that components/nodes are pure power functions, and as such, have no concept of time; rather, they are concerned with the normalization of energy. During a timestep, the change of value within the component node is instantaneous, as all inputs can be determined at a single point in time, and as such, should not affect the stability of a simulation. More specifically, a quantum 705a enters the node 710a representing a component, changed by a power function while in the node 710a, with the output quantum 715a (after passing through the node 710a) still being integral, e.g., a measure of energy. FIG. 7B at 700b illustrates two different forms of state. State comes in two forms; transferred ephemeral state (quanta) and stored state (internal packet of quanta). Input and output are not stored, rather the state of the component (as captured in a node 710b) is entirely captured within its internal state 720b. This is enabled through doing the entire node calculations at once. State 705b moving into a node 710b is transferred ephemeral state, as is state 715b moving out of a node. However, the state 720b within the node 710b is a stored state 720b. The stored state is purely captured in the internal packet of quanta of the node 710b. FIG. 7C at 700c illustrates how transferred state is naturally stable in connection with a correctly-sized timestep. The transferred state takes the form ΔT that encapsulates a timestep, such that actions that take longer than a single timestep will take some multiple of the timestep, as can be seen by the expansion of ΔT 710c to Δ2T 715c and Δ3T 720c. A timestep may be set so that such an encapsulation is possible; e.g., (within certain exceptions) the entire actions of the node 705c can take place within the timestep.

FIG. 7D at 700d illustrates a basic principle of quantum computing; that is, stability is a function of internal state of the node (e.g., 720b). A quantity with state 705d enters the node 710d. As a limit, the current quantity in a node plus the quanta attempting to move into a node can be no greater than the max quantity 715d of the node. More quantity cannot be added to the node such that the current internal quantity and the new quantity is greater than max quantity. By enforcing volume constraints, the simulation, among other things, mimics the real world where physical objects cannot occupy more space than they have. When dealing with fluid quanta, this volume preservation is crucial for maintaining the stability of the simulation. Without these volume constraints, the simulation may produce physically unrealistic results, such as objects represented by nodes collapsing or expanding uncontrollably. In simulations involving fluid flow or other phenomena where mass is conserved, these volume constraints ensure that mass is preserved correctly, as is essential for accurately modeling fluid behavior, chemical reactions, phase changes, and other processes where mass transfer is involved. However, overpassing, as described with relation to FIG. 9E, allows nodes with a max quantity that is too small for a given timestep to be handled gracefully, such that stability is retained.

Stability is also a function of the internal state 720b. Transferred state is naturally stable, as shown with reference to FIG. 7A. Internal packet of quanta accumulate energy, and have access to the simulation timestep (a global value) with the caveat that, as discussed, simulations may be separated into independent systems that have different timesteps. In the context of timesteps, more energy allows for larger timesteps. As discussed, there cannot be more quanta added to a node than the max quantity 715d. The maximum quanta for a tank, for example, is the volume of the tank. When a timestep is increased, the volume that is passed is increased, as well. So, the timestep should be of a size to ensure sufficient capacity within the node. Capacity is a normalized definition. For example, capacity in electrical engineering is the volume of a capacitor. Unlike capacity, the volume of liquid in a tank (or equivalent) is variable. For example, batteries can run out of energy, tanks can be partially empty, etc.

FIG. 9H illustrates an embodiment of a subsystem with a component that may determine a timestep size. Subsystems may be thought of as potentially having many components. Each of these components has its own maximum quantity, as described with reference to FIG. 7D. Timesteps may be chosen to be high resolution or low resolution. Actors with large amounts of physical (equiv.) quanta (liquid, fuel, etc.), should be considered when determining high resolution timesteps. These high mass components may be considered mixing devices; and may have actors of types producer 605c, store 625c and consumer 610c. As such, these components with these types of actors 905h, 910h, 915h, 920h, 925h may be considered when determining high resolution timesteps. Each of the components of the subsystem step through a timestep simultaneously. Each of these components has an RC equivalent which can be defined by

$$( \frac{{Quanta}_{internal}}{massflow} ) .$$

As such, the timesetep may be determined by the component with the smallest RC equivalent.

FIG. 9F at 900f illustrates some examples of a flowchart that can be used to determine system timesteps. The operations of flowchart 900f presented below are intended to be illustrative. In some embodiments, flowchart 900f may be accomplished with one or more additional operations not described, and/or without one or more of the operations discussed. Additionally, the order in which the operations of flowchart 900f are illustrated in FIG. 9f and described below is not intended to be limiting. mesteps. The other actors that do not impinge on system stability may be ignored.

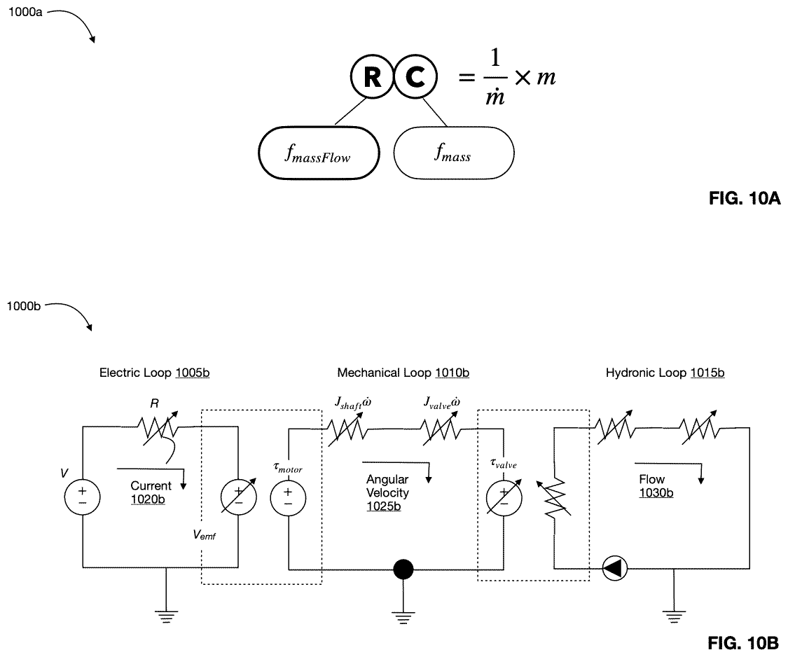

A subsystem 905f will first be divided into subsystems 910f, 915f. A subsystem may be defined by being an interlocked Electrical-Mechanical-Hydronic loop, as described with reference to, e.g., FIGS. 5A-B. A subsystem may be described as a single loop, or as an interlocked system of two or more loops. Each subsystem may have a separate flow rate defined by the nature of its loops. Two subsystems, Subsys 1 910f and Subsys 2 915f are shown in this illustrative example. They undergo the same series of steps as defined by 920f and 925f. In these subsystems, the timesteps are determined 925f. Each of the devices in the subsystem 910f is checked to determine if it a mixing device 921f. Mixing devices, in some embodiments, are those whose actor type is producer, consumer, or store, with reference to FIG. 6C. For each mixing device that was determined at operation 915f, the internal packet of quanta mass is determined 922f. The mass, in many mixing devices, is the mass of substance that the mixing device can hold. Of the mixing type actors, the one with minimum mass is chosen 923f. The chosen mass is then divided by the flow rate for the subsystem to arrive at the largest timestep that the specific subsystem (T1 930f for Subsystem 1 910f, T2 935f for Subsystem 2 915f) can handle without destabilizing 924f. The flow rate is described with more specificity with reference to FIGS. 10A and 10B. At 940f, the smallest of the subsystem timesteps is used as the system timestep. This may need to be modified, when a phase change is expected to be encountered in the subsystem. This may happen when quanta of types Fluid: liquid-gas phase change 625b, Fluid: solid-liquid phase change 630b, or other such phase change quanta are used by the nodes in the subsystem. In such a case, the timestep is set, at least in part by the media phase change derivative. This is explained in more detail with reference to FIG. 9B and the surrounding text.

FIG. 10B at 1000b illustrates an example subsystem described as a series of interlocking loops. Within these loops, equipment (not shown) determines the resistance and counterforce. As previously mentioned, the hydronic and mechanical systems provide a normalized value that corresponds to an RC value. The normalized RC value is the minimum mass/flowrate, as shown with reference to FIG. 10A at 1000a. FIG. 10B at 1000b illustrates an example demonstration of Kirchoff's laws which describe, in this instance, how to determine flow rate for a mixing device. Each subsystem may be decomposed into a series of loops, a loop for electrical activity 1005b which current 1020b flows through; a loop for mechanical activity 1010b, which angular velocity 1025b flows through; and a loop for hydronic activity 1015b, which has flow 1030b. Within the loops, power flows clockwise. The specific nodes within the loop determine specific resistance and capacitance, with the caveat that the mechanical and the hydronic systems have resistance and capacitance equivalents. In the described embodiment, the mixing device is a pump. For example, the pump in question, has a hydronic cycle, which defines how much exertion the pump motor must exert. This, in turn defines how much electricity will need to be used to power the pump motor. This can be described as a hydronic loop 1015b linked to a mechanical loop 1010b, which is linked to an electrical loop 1005b, representing the liquid in the pump (hydronic), the torque motor that moves the liquid (mechanical), and the electricity (electric) used for the motor. Kirchoff's second law states that the directed sum of the potential differences around any closed loop is zero. Using Kirchoff's second law, the linked equations are simultaneously solved: for the hydronic loop findQsuchthatΣΔP=0; for the mechanical loop, findωsuchthatΣτ=0, and for the electrical loop is findIsuchthatΣv=0.

FIG. 8 illustrates overstepping 800: what happens when the amount of quanta to be moved into an internal packet of quanta of a node during a timestep is greater than the internal packet of quanta size. The connections between nodes in the heterogenous neural network governs which quanta will move into a node. With reference to FIG. 5D, the motor 530d will receive input from the router 515d. The mixing node 815 receives quanta input 803 from a downstream node (not shown). A governor, using the type of quanta, the actor type, and other properties available to it (such as flow pipe length, etc) determines what sort of other factors, such as inline resistance, as shown with reference to FIG. 5E, will affect the quanta prior to reaching the node 805. Once all this information is known, the governor modifies the quanta as required, giving the transferred quanta 810 that will be used in the node 815. The mixing step then happens during a timestep. In this mixing step, the amount of transferred quanta is subtracted from the quanta internal 820 to the node at the beginning of the timestep. This is because as much internal packet of quanta is assumed to move out as the transferred quanta moves in. Then, the quanta 810 and the leftover internal packet of quanta is mixed 815, giving a new state 830. How the quanta is mixed depends on the type of quanta, the length of timestep, and other factors such as the properties of the quanta being mixed, their initial temperatures, the mixing process, whether there is a phase change, and energy loss to surroundings. More information can be found with reference to FIGS. 9B, 9D, 9E, and the surrounding text. In some embodiments, fluids may be mixed using an average of state between the different fluids. The quanta 830 with the new state 825 is then used as the output of the node.

A concept of a media model is employed for the prediction of media alterations. The derivative of the media curve may be utilized for adjusting the timestep. For instance, a specific heat-temperature curve can be identified as the media curve for water. FIG. 9A at 900a represents a sample water mixing graph over time when a phase change does not take place. There is very little energy change over the timestep. In such instances, in some embodiments, the energy change may be ignored. In some embodiments, the energy change may still be considered. FIG. 9B at 900b represents a mixing temperature graph when a phase change takes place. As can be seen, the temperature changes varies rapidly. In the course of phase transitions, such as the transition from liquid to steam, the derivative of the curve becomes substantial, necessitating a reduction in the timestep that corresponds to the media derivative. This adjustment enables the capture of the system's dynamics accurately during the phase transition. The formulaTimeStep_{Max}=CapacitiveForm×CₚDerivative, where CₚDerivative defines the media state response, and may be used as a factor to define the timestep for a subsystem where a phase change is expected. FIG. 6B defines types of Quanta, as previously discussed. Certain types of quanta are defined as phase change quanta. Two of these are Fluid: Liquid-Gas phase change quanta 625B and Fluid: Solid-Liquid Phase Change quanta 630B. When these quanta are interacting with a node, then the timestep for the subsystem with the phase-change quanta may modify the timestep to include the derivative of the phase change, as noted above.

FIG. 9C illustrates some actions 900c that take place during a timestep. Overall, quanta moves from the input through the internal state and to the output in a single timestep. This example subsystem includes three nodes: a boiler, e.g. 910c connected to a pump e.g., 912c connected to a radiator, e.g., 914c. The example timestep includes three steps: The first 905c includes updating the internal state of each of the subsystem nodes which consists of modifying state of the internal packet of quanta of the boiler 911c, the pump 913c, and the radiator 915c using the power function (the series of equations that make up the activation function of a node). The second step 920c includes moving the internal state of each of the nodes 922c, 924c, 926c into the output 921c, 923c, 925c of each of the nodes. The third step 930c includes moving the output from the current node 931c, 933c to the next-in-line input 934c 936c.

FIGS. 9D and 9G illustrate examples 900d, 900g of behavior some of the different internal packet of quanta forms. This may be invoked during a timestep to determine the internal quanta and the quanta that will be output when a component's actor is of a mixing type. There are different internal packet of quanta forms that behave differently during the internal step. When a timestep is small enough to fit all of the input into the internal packet of quanta of an actor—a high-resolution timestep—then there may be a different behavior in some of the different internal packet of quanta forms. Five basic forms discussed here are the mixing form 905d, single quanta 910d, flow through 930d, FIFO 945D and gated flow through 955d. The concept of mixing forms can be categorized into two types discussed with reference to FIG. 9G at 900g. The two types are constant media 980g and variable media 985g. In constant media, the quantity of an input packet of quanta remains consistent regardless of the inputs and outputs. Examples of constant media include buffer tanks, sand beds, geothermal heaters, DHW tanks, and flywheels. In this scenario, input 907d enters the component. The internal state now consists of the original internal state 909d minus the input 907d. The output 911d matches the input material quantity 907d. The input and the internal packet of quanta, excluding the input—amount 909d—are blended together, thereby updating the internal packet of quanta state. This mixing can be achieved through methods such as averaging, employing a dilution curve (detailed in FIG. 9E), or alternative techniques. Consequently, the output 911d retains the same quanta amount as the input and shares the same state (e.g., A+B) as the mixed internal packet of quanta.

Variable media 985g refers to media that depletes quanta as it is utilized. Examples of variable media encompass batteries, compressed air systems, open tanks, fuel tanks, capacitors, and more. Its behavior is fundamentally akin to constant media, wherein the state of the input packet of quanta, subtracted from the current quanta, is blended to generate a new quanta state, which is then distributed to both the internal packet of quanta and the output quanta. However, in this context, although the output quanta retains the same size as the input packet of quanta, unlike the constant media, the quantity of input packet of quanta 907d is deducted from the internal packet of quanta 909d.

With reference to FIG. 9D, in the single quanta form a new quanta replaces the old quanta. For example, a timestep can be thought of taking two conceptual steps. In the first conceptual step, the single internal packet of quanta 913d, is moved from the internal state to the output 915d. In the second conceptual step, the input packet of quanta 921d is shifted into the internal packet of quanta location 923d. Here, the internal packet of quanta never holds more quanta than its max quanta.

The flow through form 939d, is a first in first out system, with any shared material in the internal state not mixed. The first quantum packet to enter the queue is the first item to be removed from it. For example, when a packet of liquid is in a pipe of a first temperature and a packet of liquid is to move through the pipe at a second temperature, the first packet is pushed out at the first temperature, with the second packet being pushed out at the second temperature. In the example shown, a quanta of type B 933d is in the node. During the timestep, at step 1, an input packet of quanta of type A 921d comes in and metaphorically pushes the quanta of type B to the output 935d. During the same (or a different) timestep, another quanta of type C 937d enters. It proceeds to move into the internal packet of quanta, pushing the A 939d, now in the internal packet of quanta location, out to the output 941d. A gated flow through type also exists. This may take the form of a flow-through form that is only open during certain states, such as a valve with an on and off setting, an electrical circuit, etc. (138) In some embodiments, there may be two types of resolution for timesteps: high resolution and low resolution. High resolution refers to a scenario where the timestep is sufficiently small, allowing the internal state to accommodate all the material that is introduced into it during that timestep. Conversely, low resolution occurs when the timestep is relatively large, causing more material to enter a node than can be contained within its internal state.

Two forms have stability requirements during low resolution timestepping, the mixing form 904e and the flow through form 902e, to ensure stability in the simulation. FIG. 9E illustrates examples of these forms 900e during a low resolution timestep. During a low resolution timestep more material is pushed through a node than the node can fit. A pipe, for example, has a very small internal packet of quanta. If a timestep were forced to be tiny enough for each pipe-full of, e.g., water, the simulation would run very slowly indeed. Instead of requiring tiny timesteps when tiny nodes are present, as an alternate, overpassing (e.g. FIG. 8) is used to allow all of the material to be handled gracefully and accurately within the simulation. The flow-through form e.g., 902e, may be handled in two conceptual steps. At the beginning of a timestep, the amount of material to be processed during the timestep is at the “In” location of the node 935e, as shown with reference to FIG. 9C at 912c. Depending on timestep size and maximum volume of the node, there may be more material at the “In” location than the maximum size of the node. Let's consider that the internal volume of a node is already at full capacity. In some embodiments, the internal quanta is always considered full for certain actor types. In some embodiments, constant media 980d, is always considered full, while variable media 985d may not be considered full. Media type may be a different type that nodes may be divided into. In some embodiments, different actor types may be constant media 980d while other actor types may be variable media 985d. In step 1 907e, in the example shown, there will be a packet of quanta of type B 911d that is three times the size of the available space. In such a case, we determine the average state of the output quanta by taking the mean between the current internal packet of quanta state 939e and the state of the incoming quanta. The amount of incoming quanta is, generally, the amount of incoming quanta minus an amount the size of the internal packet of quanta allowed in the node. This is because, in some embodiments, it is assumed that the current node is full. In this case, two of the B's and the A are the quanta that will be mixed. This is equivalent to BBA flowing out of the node, with B staying in the node. As BBA is a single quanta packet handled in a single timestep, the state of BBA must be determined for the output of this timestep for this node 935e, In step 2 912e, we then transfer a quanta, equivalent in size to the incoming quanta, and with the calculated averaged state, to the “out” location. Additionally, we move a quanta equal in size to the maximum internal packet of quanta state, with the initial state of the incoming quanta, into the internal packet of quanta of the node. As an example, the three B quanta 911d have a state of 60° F. The internal packet of quanta is one A quanta 909e with the state of 75° F. Two of the B quanta (The B quanta amount minus the internal packet of quanta amount) will pass through the node 905e along with the original A quanta. Their out temperature state 917e, will be (60+60+75)/3; that is, 65°. The internal packet of quanta will then be the remaining B quanta 913e with the original temperature 60° F.

The mixing form 904e, for low-resolution timesteps, in step 1 927 adds the amount of quanta 939e initially in the node 935e to the quanta 929e moving into the node 935e, as the mixing form represents devices that mix materials that flow into them. Similar to the flow-through method, the amount of quanta in the node is subtracted from the amount of quanta that are to be moving into the node to determine how much quanta will be moving out of the node. In this example, three units of quanta with state B 929e will be moving into this node that holds one unit of quanta, with its current occupant with state A 935e. In step 2 933e, the two quanta are mixed, leaving some mixed quanta 937e in the original node, with the rest of the mixed quanta 945e moved out of the node. In some embodiments, the mixing may average the different states as in the flow-through form In some embodiments, the mixing calculation is done twice: once for the material that remains in the node 927e; in this case the last fourth of the quanta volume with reference to time 939e is left in the node 935e, (BBBA* percent left in node, e.g. ¼) and once for the material that is passed through 943e, (BBBA* percent exiting from the node, e.g. ¾). The mixing may be averaged here between the nodes, or a dilution curve model, as shown, may be used. To use the dilution curve, for constant media 980d, two dilution integrals (such as Fick's second law of diffusion, a dilution calculation based on conservation of energy and heat transfer, etc.) are taken: the first determines the dilution of the material that will remain in the internal packet of quanta 939e; the other determines the dilution of the material that will be output 941e. In some cases, dilution is used to determine state. For the first, to determine the composition of material within the node, an integral from the material moving into the node 929e during the timestep to the total material mixed (material in the internal packet of quanta 939e plus the quanta moving into the node 929e) is take over the two states of the material (e.g., A, B). This should give the percentage of material left in the internal packet of quanta of all the material that was moved in the timestep runs from the integral 939e. The rest of the integral is over the area from 0 to the percentage of total material that will be output 941e, with respect to the states (A, B) of the material, (in this example case, § 0/(A, B), is the material that will be output. Calculations for constant media 980d and variable media 985d may be different, as in constant media, the same amount of quanta remains in the node, while with variable media 985d, the input amount is subtracted from the previous amount in the node, such that at the end of a timestep, there is an input quanta less of volume in the node.

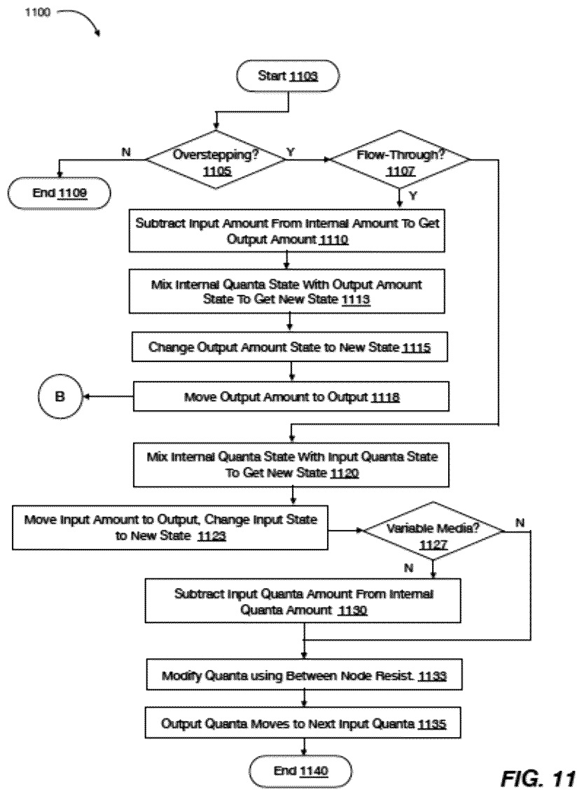

FIG. 11 illustrates a method of determining device behavior during a timestep for actors whose volume granularity is smaller than the volume granularity of a chosen timestep. This method may be called “overstepping” and may be used when a high resolution timestep is used. The operations of method 1100 presented below are intended to be illustrative. In some embodiments, method 1100 may be accomplished with one or more additional operations not described, and/or without one or more of the operations discussed. Additionally, the order in which the operations of method 1100 are described below is not intended to be limiting.

The method begins in step 1103 and proceeds to step 1105, where, during a timestep in a simulation, the amount of material (quanta) that will be used in the device during the timestep is determined. Prior to the method beginning, the structure being modeled may be warmed up. This may constitute running a simulation associated with the structure and the equipment for a period of time to warm up the simulated structure to values that might match values in the actual building. This is discussed in patent application Ser. No. 17/193,179, now U.S. Pat. No. 11,861,502, filed on Mar. 5, 2021, the entirety of which is incorporated by reference herein. At decision point 1110, if this volume is greater or equal than the volume of the device, then, at step 1115, the flowchart ends, as no changes are required during the timestep for this device. If the volume that will interact with the device during the timestep is greater than the volume of the device, then this device may require special treatment during the timestep. This is shown at 1210, where three times the device volume will be used during the timestep. Determining the volume may involve looking at the length of the timestep, and multiplying it by the flow volume, or some other simulation-specific function. The new quanta volume may also have an original state associated with it. At step 1120, a new quanta volume that will be handled by the device during the timestep is received. This could be received through simulation-specific actions. At step 1125, the size of the device quanta is extended to accommodate both the original quantity of quanta in the device and the new quanta volume that will be processed during the timestep, as shown with reference to 1220. The original device volume is shown at 1225.

At step 1130, the new volume of quanta is moved into the device, as illustrated at 1230. The device now holds the original quanta at the time the timestep started, and the new quanta that will be processed during the timestep. The new quanta may have a different state 1210 than the original quanta volume 1218 already in the device 1215. As an example, if the quanta is water, and the state is heat, the new quanta may be at 45 degrees, while the original quanta is at 75 degrees. At step 1135, the new quanta volume (with a new quanta state) and the original quanta volume (having an original quanta state) are mixed, as shown at 1235, producing, e.g., a uniform quanta volume, which may be termed a timestep volume. In some cases, averaging is used. For example, if the quanta is water, and the state is heat, the heat of the new water (44 degrees) and the original water (75 degrees) will be mixed together. As there is three times as much new water as original water, the mixed temperature may be 51.75 degrees. In some cases, dilution is used to determine state. When a phase change occurs during the timestep, that should be taken into account. Other sorts of mixing are described with reference to FIG. 8 and the surrounding text. During the timestep in the simulation, the device may change state of its quanta a certain amount by mixing in this fashion, the quanta may be uniform throughout the quanta volume, such as here, when quanta are at the same temperature. At step 1140, the state change from the timestep-a timestep state-will be added to all the quanta volume. For our water example, the water may have a certain amount of heat 1240 applied to it for the timestep length, producing a new state (temperature) in that volume 1245. At step 1145, the new volume of quanta amount is moved outside of the device. The quanta volume 1255 may be moved outside the device in the direction 1205 that the quanta is moving. At step 1150, the quanta volume is returned to its original size 1250. At step 1155, the method ends.

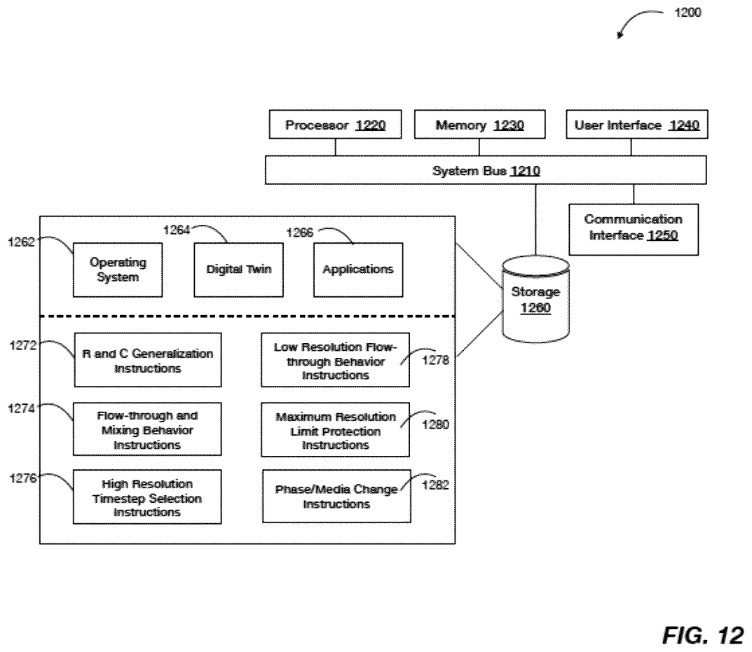

FIG. 12 illustrates an example hardware device 1300 for implementing a controller, server, or other device for defining a timestep or determining usage of devices whose volume granularity is smaller than the timestep. The hardware device 1200 may describe the hardware architecture and some stored software of one or more of the controllers 132-138, 210 previously described or may describe the hardware of another device implementing some or all of the functionality described herein such as, for example, enabling design of a digital twin before any controller has been installed. As shown, the device 1200 includes a processor 1220, memory 1230, user interface 1240, communication interface 1250, and storage 1260 interconnected via one or more system buses 1210. It will be understood that FIG. 12 constitutes, in some respects, an abstraction and that the actual organization of the nodes of the device 1200 may be more complex than illustrated.

The processor 1220 may be any hardware device capable of executing instructions stored in memory 1230 or storage 1260 or otherwise processing data. As such, the processor 1220 may include a microprocessor, field programmable gate array (FPGA), application-specific integrated circuit (ASIC), or other similar devices.

The memory 1230 may include various memories such as, for example L1, L2, or L3 cache or system memory. As such, the memory 1330 may include static random access memory (SRAM), dynamic RAM (DRAM), flash memory, read only memory (ROM), or other similar memory devices. It will be apparent that, in embodiments where the processor includes one or more ASICs (or other processing devices) that implement one or more of the functions described herein in hardware, the software described as corresponding to such functionality in other embodiments may be omitted.

The user interface 1240 may include one or more devices for enabling communication with a user such as an administrator. For example, the user interface 1240 may include a display, a mouse, a keyboard for receiving user commands, or a touchscreen. In some embodiments, the user interface 1240 may include a command line interface or graphical user interface that may be presented to a remote terminal via the communication interface 1250 (e.g., as a website served via a web server).

The communication interface 1250 may include one or more devices for enabling communication with other hardware devices. For example, the communication interface 1250 may include a network interface card (NIC) configured to communicate according to the Ethernet protocol. Additionally, the communication interface 1350 may implement a TCP/IP stack for communication according to the TCP/IP protocols. In devices 1200 that operate as a device controller, the communications interface 1250 may additionally include one or more direct wired connections to such controlled devices or connections to separate I/O modules (not shown) providing such connections. In applications where the device 1200 is deployed in the context of an HVAC system, the communications interface may communicate according to an appropriate protocol such as BACnet. Various alternative or additional hardware or configurations for the communication interface 1350 will be apparent.

The storage 1260 may include one or more machine-readable storage media such as read-only memory (ROM), random-access memory (RAM), magnetic disk storage media, optical storage media, flash-memory devices, or similar storage media. In various embodiments, the storage 1260 may store instructions for execution by the processor 1220 or data upon with the processor 1220 may operate. For example, the storage 1260 may store a base operating system 1262 for controlling various basic operations of the hardware 1200.

The storage 1260 additionally includes a digital twin 1264, such as a digital twin according to any of the embodiments described herein. As such, in various embodiments, the digital twin 1264 includes a heterogeneous and omnidirectional neural network. The storage also includes one or more applications 1266 that may make use of the digital twin 1264. For example, the applications 1266 may include an application for controlling a system of HVAC equipment, an application for providing a user interface of current and predicted state, an application for allowing a user to run simulations against one or more hypotheses, an application for assisting product design with simulation and other digital twin-derived insights, or any other application that may make use of a digital twin 1264. Thus, in some embodiments, the applications 1266 may correspond to one or more nodes of the controller 210 such as the solver engine 250 or semantic translator 232. In some embodiments, some or all of the applications 1266 may not be coresident in the storage 1260 with the digital twin 1264 and, instead, may be run on other systems that access the digital twin 1264 as needed with remote calls, e.g., via the communications interface 1250 and an application programmer interface (API) (not shown).

In embodiments where the hardware device 1200 enables initial creation of a digital twin, the storage 1260 may store software for facilitating such function: a digital twin & template library, digital twin composition instructions, and digital twin training instructions. The digital twin & template library may store the building blocks from which the digital twin may be constructed or modified. As previously noted, at some levels, the digital twin is composed from the combination of smaller digital twins and, as such, the digital twin & template library may store additional digital twins that may be incorporated into the larger digital twin. Put another way, where the digital twin is to be defined at the full system level, the digital twin & template library may store previously-created component digital twins, equipment digital twins (formed from component digital twins), or sub-system digital twins (formed from equipment digital twins). Where new component digital twins may be defined for creation of the digital twin, the digital twin & template library may also store templates from which new components may be defined and then made available in the library as new component digital twins.

Digital twin composition instructions may include instructions for combining smaller digital twins together to compose the digital twin. To accomplish such composition, the digital twin composition instructions may, based on a determination that two digital twins (e.g. from the library) should be connected at particular interfaces, store such digital twins (or pointers thereto) along with an indication of the connection in the data arrangement defining the digital twin. In some embodiments, such determinations may be made automatically by software and, in some embodiments, a user may be able to indicate which digital twins should be used and how they should be connected. As such, in some embodiments, the digital twin composition instructions may provide one or more user interfaces (to be served via the user interface or the communications interface) for enabling a user to graphically compose a digital twin, which the digital twin composition instructions may then translate into a data structure for storage as, or inclusion in, the digital twin (where the full system is being defined) or the digital twin & template library (where a lower level digital twin is being defined for later use). Thus, the digital twin composition instructions may correspond to the digital twin creator 218, may present an interface such as interface for building the digital twin, or may present another interface for defining digital twins.

Digital twin training instructions may, after the digital twin has been composed, employ one or more training methods to better adapt the textbook activation functions of the digital twin to real world conditions. For example, the digital twin training instructions may execute a gradient descent or other learning algorithm to tune the parameters of the digital twin before deployment. Such training may utilize training data gathered from the specific real world system being modeled or from a system that is sufficiently similar to the real world system being modeled.

Where the device 1200 is intended to use the digital twin for a runtime application (such as autonomous building control), the storage 1260 may include software for facilitating such activity. The digital twin learning instructions may, during runtime, further train the digital twin 1264 based on run-time observations from the real-world system it models. As such, in some embodiments, the digital twin learning instructions may be similar to, identical to, or even leverage at least some of the same instructions as the digital twin training instructions. The digital twin learning instructions may correspond, for example, to the learning engine 268 step engine of the controller 210. By tracking the operation of the real world system(s), the digital twin learning instructions may not only account for deviations between the system's ideal design and real world implementation at the beginning, but also later-arising deviations such as system faults, modifications, or other changes.

The digital twin resistance and capacitance generalization instructions 1272 allow non-electrical systems such as hydronic systems and mechanical systems to have normalized equations with the electrical systems so that all systems may use the same sets of basic concepts. This, in turn, allows a generalized system of physics principles to be used across a subsystem, a system, and a digital twin, greatly simplifying the systems of equations within the nodes that themselves make up components, which make up equipment, which make up subsystems, and so on. For example, where a pump is simulated, it may include an electrical system 1005, a mechanical system 1010 and a hydronic loop 1015, all of which can be normalized.

The flow-through and mixing behavior instructions 1274 work in connection with the digital twin resistance and capacitance generalization instructions 1272 to work out the flow for the various subsystem systems in a digital twin 1264—the high resolution timestep instructions 1276. As the different types of systems (electrical 1005, mechanical 1010 and hydronic 1015) can be normalized, a generalized flow for each subsystem can be determined. Using the flow for the subsystem and the amount of mass in the various mixing nodes of the subsystem, a minimum timestep capable of handling the smallest mixing device can be determined for each subsystem. The minimum timestep of all the subsystems may then be used to determine the high resolution timestep selection. These instructions are described with greater detail with reference to FIG. 9F and the surrounding text.

The timestep chosen using flow-through and mixing behavior instructions 1278 may produce timesteps that are too high for smaller types of actors, such as pipes, whose amounts of mass are not expected to matter overall in the simulation. However, the mass in these actor types must be handled gracefully to produce a correctly-behaving simulation. As discussed earlier, without a way to handle overages, too-long timesteps can lead to inaccurate prediction of flow dynamics, instability issues, and so on. When a timestep is too big to handle the volume in any actor type, including the mixing types, low resolution flow-through behavior instructions 1278 may allow the simulation to run correctly with any size timestep. The low resolution flow-through behavior instructions 1278 do have the caveat that the timestep cannot be so high that it is greater than the length of the simulation. Other than that, any simulation timestep can be used in concert with the low-through and mixing behavior instructions 1278 to run a stable simulation. These instructions are described with more detail with reference to FIG. 9E and the surrounding text.

Maximum resolution limit protection instructions 1280 are used in concert with the flow-through and mixing behavior instructions 1278 to ensure that a given piece of equipment/component/node is handled correctly by, among other instructions, the low resolution flow-through behavior instructions 1278. Maximum quantity 715d is an inherent part of each node; during the running of a simulation, as shown with reference to FIG. 7d, the maximum quantity allowed in a node cannot be broached.

During a simulation, a phase change (such as water turning into steam) may happen. Such a phase change may produce a sharp discontinuity in multiple properties such as density, temperature, and pressure. If these sharp oscillations are not handled with care and thought, the simulation may produce oscillations, energy imbalances, temperature stabilities, or unrealistic results. The rapid rise and fall of temperature in a sample phase change is shown with reference to FIG. 9B. To prevent these problems, phase/media change instructions 1282 may be used to determine when a much smaller timestep may be used.

While not shown, the storage may include additional instructions, such as instructions for implementing on or more of the functions described in connection with the controller 210 of FIG. 2. It will also be apparent that various information described as stored in the storage 1260 may be additionally or alternatively stored in the memory 1230. In this respect, the memory 1230 may also be considered to constitute a “storage device” and the storage 1260 may be considered a “memory.” Various other arrangements will be apparent. Further, the memory 1230 and storage 1260 may both be considered to be “non-transitory machine-readable media.” As used herein, the term “non-transitory” will be understood to exclude transitory signals but to include all forms of storage, including both volatile and non-volatile memories.

While the hardware device 1200 is shown as including one of each described node, the various nodes may be duplicated in various embodiments. For example, the processor 1220 may include multiple microprocessors that are configured to independently execute the methods described herein or are configured to perform steps or subroutines of the methods described herein such that the multiple processors cooperate to achieve the functionality described herein, such as in the case where the device 1200 participates in a distributed processing architecture with other devices which may be similar to device 1200. Further, where the device 1200 is implemented in a cloud computing system, the various hardware components may belong to separate physical systems. For example, the processor 1220 may include a first processor in a first server and a second processor in a second server.

It should be apparent from the foregoing description that various example embodiments of the invention may be implemented in hardware or firmware. Furthermore, various exemplary embodiments may be implemented as instructions stored on a non-transient machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, and the like represent various processes which may be substantially represented in machine readable media and so executed by a computer or processor, whether or not such computer or processor is explicitly shown.

Although the various example embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

We claim:

1. A method executed by at least one processor for performing a timestep of a simulation, the method comprising:
during a timestep:
receiving an input packet of quanta at a node;
mixing a portion of the input packet of quanta with an internal packet of quanta of the node producing a mixed quanta;
moving the mixed quanta to an output of the node; and
moving an unmixed portion of the input packet of quanta into the node.

2. The method of claim 1, wherein mixing a portion of the input packet of quanta with the internal packet of quanta of the node producing a mixed quanta comprises averaging a state of the mixed quanta and a state of the internal packet of quanta.

3. The method of claim 1, wherein mixing a portion of the input packet of quanta with the internal packet of quanta of a node producing a mixed quanta comprises using a dilution function to determine state of the mixed quanta.

4. The method of claim 3, wherein moving an unmixed portion of the input packet of quanta into the node further comprises using a dilution function to determine state of the input packet of quanta.

5. The method of claim 1, further comprising a maximum capacity of the node, and wherein the unmixed portion of the input packet of quanta is less than or equal to the maximum capacity of the node.

6. The method of claim 1, wherein the node is at least a portion of a simulated device.

7. The method of claim 6, wherein the node is in a heterogenous neural network.

8. The method of claim 7, wherein the quanta has state.

9. The method of claim 8, wherein mixing a portion of the input packet of quanta with the internal packet of quanta producing a mixed quanta comprises mixing a state of the input packet of quanta with a state of the internal packet of quanta.

10. The method of claim 9, wherein the state comprises temperature.

11. A computing system that determines node behavior during a timestep executed by at least one processor, comprising:
during a timestep:
receiving an input packet of quanta at a node,
mixing a portion of the input packet of quanta with an internal packet of quanta of the node producing a mixed quanta;
moving the mixed quanta to an output of the node; and
moving an unmixed portion of the input packet of quanta into the node.

12. The computing system of claim 11, further comprising, during the timestep, moving the mixed quanta at the output of the node to a next node input.

13. The computing system of claim 12, wherein the unmixed portion of the input packet of quanta is less than or equal to a maximum capacity associated with the node.

14. The computing system of claim 13, wherein the unmixed portion of the input packet of quanta is mixed with at least a portion of the mixed quanta.

15. The computing system of claim 13, wherein the node is a heterogenous node.

16. The computing system of claim 15, wherein the heterogenous node has behaviors that modify the input packet of quanta.

17. The computing system of claim 16, wherein the behaviors are associated with an activation function of the node.

18. A non-transient machine-readable storage medium comprising a plurality of instructions which, when executed by a computer cause the computer to execute a timestep, comprising:
receiving an input packet of quanta at a node,
mixing a portion of the input packet of quanta with an internal packet of quanta of the node producing a mixed quanta;
moving the mixed quanta to a next node; and
moving an unmixed portion of the input packet of quanta into the node.

19. The non-transient machine-readable storage medium of claim 18, further comprising a maximum capacity of the node, and wherein the unmixed portion of the input packet of quanta is less than or equal to the maximum capacity of the node.

20. The non-transient machine-readable storage medium of claim 19, further comprising the mixed quanta equaling volume of the input packet of quanta minus the maximum capacity of the node.
